(19) United States
(12) Patent Application Publication
(10) Pub. No.: US 2019/0180272 A1
(43) Pub. Date: Jun. 13, 2019

(54) DISTRIBUTED IDENTITY PROTECTION SYSTEM AND SUPPORTING NETWORK FOR PROVIDING PERSONALLY IDENTIFIABLE FINANCIAL INFORMATION PROTECTION SERVICES

(71) Applicant: Janathon R. Douglas, Greenwood, AR (US)

(72) Inventor: Jonathan R. Douglas, Greenwood, AR (US)

(21) Appl. No.: 15/839,679

(22) Filed: Dec. 12, 2017

(51) Int. Cl. G06Q 20/34; G06Q 20/32; G06Q 20/20; G06Q 20/40; G06Q 30/06; G06F 21/62; H04L 29/08

(52) U.S. Cl. CPC G06Q 20/354; G06Q 20/3274; G06Q 20/202; G06Q 20/4014; H04L 67/1097; G06Q 30/0641; G06Q 30/0633; G06F 21/6245; G06Q 20/403

(57) ABSTRACT

A distributed identity protection system (DIPS) service network, wherein the registration of a credit or debit card account on the service network, the alphanumerical characters representing a consumer's personal identifiable financial information (PIFI) data record, associated with the credit or debit card account, is physically divided into multiple PIFI data fragments, and then these PIFI data fragments are automatically stored in multiple network-distributed data record storage locations. Then, during financial payment transactions, these network-distributed data fragments are temporarily and automatically recombined to create the original complete PIFI data record, so as to authorize and complete the financial payment transaction, and once the financial payment transaction has been completed, the recombined/recreated PIFI record is immediately destroyed in an automated and transparent manner.

### BACKGROUND OF INVENTION

### Field of Invention

The present invention relates to improvements in the field of financial payment technology and security, in both online e-commerce and brick-and-mortar commerce environments, and more particularly, to new and improved ways of and means for protecting personal and financial identify types of information in both electronic and brick-and-mortar streams of commerce, where trillions of dollars are at risk daily due to fraud, theft and unauthorized access to user identification information.

### Brief Description of the State of Knowledge in the Art

Theft of personal information and personal financial information continues to be a serious problem worldwide.

FIG. 1A schematically illustrates the primary data elements of any Personally Identifiable Information (PII) record 1A comprising: a person's first and last name; postal address; email address; and phone number. FIG. 1B schematically illustrates the primary data elements of any Personally Identifiable Financial Information (PIFI) record 1B comprising: a person's credit (or debit) card information; credit (or debit) card expiration month; credit (or debit) card expiration year; CVV number; first and last name; postal address; email address; and phone number.

FIG. 2A illustrates a conventional prior art e-commerce environment 3 in which a consumer involved in an e-commerce transaction with a merchant at its ecommerce website 4A, provides a PIFI record 1B to the merchant while making an electronic payment at the e-commerce site 6A, using the consumer's credit or debit card issuer 14 and the consumer's bank 11, communicating with the ecommerce website 6A by way of a payment gateway system 12 enlisted by the merchant. During the ecommerce transaction, the PIFI record is stored in the merchant's database system 9.

As shown in FIG. 2B, this prior art e-ecommerce transaction is described in greater technical detail. Specifically, as indicated at Block A, the consumer completes an order via an e-commerce-enabled shopping cart on the merchant's online store. As indicated at Block B, the shopping cart submits the order to a payment gateway 12, which then forwards a request to the credit card issuer for verification. At Block C, the payment gateway system sends credit card information to the credit card issuer 14 for validation. As indicated at Block D, the card issuer validates the credit card information against information stored in databases 5A. As indicated at Block E, a request is made by the consumer's bank for payment verification. As indicated at Block F, the consumer's bank processes the payment verification request. As indicated at Block G, the funds are transferred from the consumer's bank account 11 to the merchant's bank account 9 in the amount to cover the price of the items being purchased. As indicated at Block H, the payment verification is sent back to the e-commerce site operated by the merchant who received payment from the consumer's bank. During this transaction, a database is used by the merchant (and others) to store the consumer's personally identifiable financial information (PIFI). If this database 5A is compromised in any way, then an attacker is well positioned to commit identity theft and or fraud against the consumer.

Similarly, FIG. 2C illustrates a conventional prior art brick-and-mortar retail environment 3 in which a consumer involved in a retail point of sale (POS) transaction with a merchant, is supported by the merchant's POS terminal system 4B. During the POS transaction, the consumer provides his or her PIFI record 1B to the merchant while making an electronic payment at the POS terminal for the purchase. This involves using the consumer's credit or debit card issuer 13 and the consumer's bank 10, communicating with the merchant's POS terminal 6B, by way of a payment gateway system 12 configured and employed by the merchant 8. During the POS-based payment transaction, the consumer's PIFI record is stored in the merchant's POS database system 5B and is vulnerable to unauthorized access.

As shown in FIG. 2D, this POS transaction is described in greater technical detail. Specifically, as indicated at Block A, the consumer checks out his or her purchases using a POS Terminal 6B in a merchant's brick-and-mortar store 4B. As indicated at Block B, the POS terminal sends payment information to the payment gateway 12, which then forwards a request to the credit card issuer for verification. At Block C, the payment gateway sends credit card information to the credit card issuer for validation. As indicated at Block D, the card issuer validates the credit card. As indicated at Block E, a request is made by the consumer's bank 10 for payment verification. As indicated at Block F, the consumer bank processes the payment verification request. As indicated at Block G, the funds are transferred from the consumer's bank account 11 to the merchant's bank account 8 for the price of the purchased items. As indicated at Block H, the payment verification is sent back to the POS terminal 6B at the merchant's brick-and-mortar store 4B, which received payment from the consumer's bank 10. During this transaction, a database 5B is used by the merchant (and others) to store the consumer's PIFI 1B. If this database 5B is compromised in any way, then an attacker is well positioned to commit fraud against the consumer.

While new smart payment card technologies, such as EMV (EuroPay, MasterCard and Visa) cards, storing their data on integrated circuit (IC) chips, offer some protection against credit and debit card theft and unauthorized use, they offer no protection against online transactions or data storage breaches. Payment cards that comply with the EMV standard are often called Chip and PIN or Chip and Signature cards, depending on the authentication methods employed by the card issuer. The financial institutions that issue these cards, along with their insurance companies and individual consumers, collectively lose billions annually to credit and debit card theft and unauthorized use.

Presently, unauthorized use of credit and debit cards is a simple feat for criminals to accomplish and is, in most cases, not detected until well after the fact. Similarly, other more complicated forms of credit and debit card fraud also go undetected and unabated until it is too late.

Visa and MasterCard have also developed standards for using EMV cards in devices to support “card not present” transactions over the telephone and Internet. MasterCard has the Chip Authentication Program (CAP) for secure e-commerce. Its implementation is known as EMV-CAP and supports a number of modes. Visa has the Dynamic Passcode Authentication (DPA) scheme, which is their implementation of CAP using different default values.

Standard prior art methods of fraud or unauthorized use detection have been limited to programs that develop spending trends or patterns. Only when a purchase does not fit those spending trends or patterns is the card issuer alerted regarding a suspicious purchase, whereby the system automatically contacts the card holder for verification of the purchase.

Historically, despite all efforts made to detect and thwart credit and debit card fraud, there still exist a great need in the art for a new, improved method of and apparatus for protecting the PIFI used in authorizing financial payment transactions, at online at e-commerce websites as well as at POS terminals at brick-and-mortar stores, in ways that overcome the shortcomings and drawbacks of prior art methods and technologies.

### OBJECTS AND SUMMARY OF THE INVENTION

Accordingly, a primary object of the present invention is to provide a new, improved method of and apparatus for protecting the PIFI records used in authorizing financial payment transactions, at online at e-commerce websites POS terminals and brick-and-mortar stores, in ways that overcome the shortcomings and drawbacks of prior art methods and technologies.

Another object of the present invention is to provide a novel network Distributed Identity Protection System (DIPS) and supporting service network that protects a consumer's PIFI records during electronic payment transactions relating to online and brick-and-mortar purchases.

Another object of the present invention is to provide a novel network DIPS and supporting service network, wherein the alphanumerical characters representing a consumer's PIFI record is physically divided into multiple (i.e. two or more) data fragments, and then these data fragments are automatically stored in multiple network-distributed data storage locations, and then during financial payment transactions, these network-distributed data fragments are temporarily and automatically recombined to create the original complete PIFI record, so as to authorize and complete the financial payment transaction, and once the financial payment transaction has been completed, the recombined/recreated PIFI record is immediately destroyed in an automated and transparent manner.

Another object of the present invention is to provide a novel network DIPS and supporting service network, wherein the PIFI data fragments are stored in network distributed data storage servers maintained with data storage networks that can be implemented in various ways and using different means, such virtual cloud storage networks, distributed non-relational file storage systems (e.g. HaDoop), and many different possible data fragment network storage configurations, supporting virtually any number of data storage nodes (i.e. M1, M2, M3, M4, M5 . . . )

Another object of the present invention is to provide a new and improved method of and apparatus for preventing fraud and/or unauthorized use of financial accounts employing novel methods of personal identity data distribution and recombination techniques.

Another object of the present invention is to provide a new and improved method of and apparatus for authorizing electronic payments using either credit or debit accounts and network-distributed data fragments generated from PIFI records, stored in database servers, and accessed and recombined during payment authorization transactions supported on the service network of the present invention.

Another object of the present invention is to provide a new and improved service network using mobile applications for authorizing payments from credit or debit accounts registered on the service network, for the purchase of goods and/or services at e-commerce stores and brick-and-mortar stores, without ever revealing PIFI at any time during the payment transaction.

Another object of the present invention is to provide a new and improved method of authorizing electronic payment for the purchase of goods and/or services on a service network, comprising the steps of: (a) registering a credit or debit account of a consumer having a unique personal identifiable financial information (PIFI) record, by fragmenting said personal identifiable financial information (PIFI) record into a set of data record fragments, and then storing each said data record fragment in a data record storage node maintained on a distributed network of data storage nodes maintained on said service network; and (b) when the consumer requests authorization of an electronic payment for the purchase of goods and/or services on said service network, using said credit or debit account registered on said service network, to automatically access said set of data record fragments from said data record storage nodes and recombine said set of data record fragments into a complete PIFI data record, and then use said complete PIFI data record to authorize the electronic payment for the purchase of goods and/or transaction on said service network.

Another object of the present invention is to provide a new and improved electronic service network using a mobile application for use by a consumer authorizing payment from a credit or debit card account registered on the electronic service network and having a unique personal identifiable financial information (PIFI) data record, wherein the authorized payment is used to purchase goods and/or services at an e-commerce store or brick-and-mortar store, without ever revealing the PIFI data record at any time, or to anyone, during the payment transaction.

Another object of the present invention is to provide a new and improved electronic service network comprising: a mobile phone having a mobile application installed thereon for use by a consumer to authorize payment from a credit or debit card account registered on the electronic service network and having a unique personal identifiable financial information (PIFI) data record; and a distributed network of data record storage nodes maintained on the electronic service network; wherein the credit or debit account of the consumer is registered on the electronic service network by fragmenting the personal identifiable financial information (PIFI) data record into a set of data record fragments, and then storing each data record fragment in a data record storage node maintained on a distributed network of data storage nodes maintained on the electronic service network; and wherein, when the consumer requests authorization of an electronic payment for the purchase of goods and/or services at an e-commerce store or brick-and-mortar store, using the credit or debit account registered on the electronic service network, the electronic service network automatically accesses the set of data record fragments from the data record storage nodes and recombines the set of data record fragments into a complete PIFI data record, and then uses the complete PIFI data record to authorize the electronic payment for the purchase of goods and/or services at the e-commerce store or brick-and-mortar store, without ever revealing the PIFI data record at any time, or to anyone, during the payment transaction.

Another object of the present invention is to provide a new and improved method of and system for registering credit or debit accounts maintained within banking systems, for making authorized payments for goods and services purchased at e-commerce stores and brick-and-mortar stores, using mobile computer applications that transparently access and recombine PIFI data fragments stored in different data storage servers on a data storage network, to request payment authorization from credit account and debit account authorization systems deployed on the network.

Another object of the present invention is to provide a new and improved method of and system for making payments for goods and services purchased at e-commerce stores and brick-and-mortar stores, using mobile computer applications that transparently access and recombine PIFI data fragments, stored on database servers distributed across a service network, for the purpose of requesting payment authorization by credit account or debit account authorization systems without having to ever reveal such PIFI record at any time during the payment transaction.

Another object of the present invention is to provide a new, improved method of and system for making payments for goods and services purchased at e-commerce stores and brick-and-mortar stores, using mobile computer applications that support diverse kinds of biometric user identification technologies including, but not limited to, fingerprint recognition, facial recognition, voice recognition, retinal scanning and identification, and other methods known or being developed in the art.

Another object of the present invention is to provide a new and improved method of and system for providing payment authorization to credit account or debit account authorization systems by transparently accessing and recombining PIFI data fragments stored on database servers distributed across a service network, without having to ever reveal such PIFI record at any time during the payment transaction.

When using the system and network of the present invention, a data breach will only provide a portion of a consumer's PIFI record such as when an attacker is (i) electronic-eavesdropping during an electronic payment transaction, or breaching a database containing consumer personal financial related information on the system network of the present invention.

These and other benefits and advantages to be gained by using the features of the present invention will become more apparent hereinafter and in the appended Claims to Invention.

### BRIEF DESCRIPTION OF THE DRAWINGS

The following Objects of the Present Invention will become clear when read in conjunction of the Detailed Description of the Illustrative Embodiments, and the appended Drawings, wherein:

FIG. 1A is a schematic diagram of the data schema for PII used daily in streams of commerce comprising first and last name of the consumer, postal address of the consumer, email address and phone number;

FIG. 1B is a schematic diagram of the data schema for PIFI record used daily in streams of commerce comprising credit card information of the consumer, credit card expiration month, credit card expiration year, CVV number, first and last name, postal address, email address and phone number;

FIG. 2A is a schematic representation of a prior art e-commerce system environment comprising an e-commerce website having database containing the credit card information of consumers, and a web server for serving up an e-commerce website with webpages supporting a shopping card with a payment button that is operably connected to a payment gateway system, and a plurality of credit card issuers, and merchant banks, available to consumers through the payment gateway system;

FIG. 2B is a flow chart describing the prior art process supported at an e-commerce website during a purchase transaction using a payment gateway system and credit and/or debit card issuers and merchant banks, wherein each consumer's PIFI record is entered at the e-commerce site and stored in its database servers;

FIG. 2C is a schematic representation of a prior art POS terminal system environment comprising a POS terminal system having database containing the PIFI records of consumers, and operably connected to a payment gateway system, providing access to numerous systems including a verification system supported by a credit or debit card issuer, a merchant banking system supporting a merchant bank account, and a consumer banking system supporting a consumer bank account;

FIG. 2D is a flow chart describing the prior art process supported at a POS terminal during a purchase transaction using a payment gateway system and credit card issuers and merchant banks, wherein each consumer's PIFI record is fully and completely entered at the POS terminal system and stored in its database servers, for subsequently access and data processing in payment authorization involving the consumer's credit or debit card accounts being used to make payment for a particular purchase transaction;

FIG. 3A is a schematic representation of a first illustrative embodiment of the Distributed Identity Protection System (DIPS) Services Network of the present invention supporting a merchant's e-commerce store and/or brick-and-mortar store equipped with one or more POS terminals, and a DIPS Registration Server for registering new users and creating new User Accounts on the DIPS Services Network, a DIPS Authentication Server for network login purposes, and a Personal Information Temporary Reassembly Server (PITRS) for automated and transparent recollection and reassembly of the PIFI data record fragment files into the complete PIFI record for use in initiating automated payment authorization through the merchant's payment gateway system;

FIG. 3B is a schematic representation of an second illustrative embodiment of the DIPS Services Network of the present invention supporting a merchant's e-commerce store and/or brick-and-mortar store equipped with one or more POS terminals, and a DIPS Registration Server for registering new users and creating new user accounts on the DIPS Services Network, a DIPS Authentication Server for network login purposes, and a PITRS for accessing and reassembling stored data fragments in response to payment authorization requests made through the DIPS Services Network;

FIG. 3C is a schematic representation of a third illustrative embodiment of the DIPS Services Network of the present invention supporting a merchant's e-commerce store and/or brick-and-mortar store equipped with one or more POS terminals, and a DIPS Registration Server for registering new users and creating new user accounts on the DIPS Service Network, a DIPS Authentication Server for network login purposes, and a PITRS for accessing and reassembling stored data fragments in response to payment authorization requests made through the DIPS Services Network;

FIGS. 4A and 4B, taken together, set forth a flow chart describing the steps carried out by an authorized network user when using the DIPS Service Network when to make purchase payments for a consumer purchase transaction for goods and/or services at a merchant's e-commerce and/or brick and mortar store;

FIG. 5A is a schematic diagram of a hybrid-commerce environment supporting a four (4) node DIPS Service Network according to the present invention, as illustrated in FIGS. 3A, 3B and 3C, shown comprising a POS-terminal supported brick-and-mortar store, an e-commerce website, and a DIPS Registration Server for registering new users and creating new user accounts on the DIPS Services Network, a DIPS Authentication Server for network login purposes, and a PITRS;

FIG. 5B is schematic representation of a Distributed Data Storage Module used as a node in the DIPS Service Network of the present invention, wherein (i) an I/O module for interfacing with the TCP/IP infrastructure supporting the DIPS Service Network, receiving encrypted data fragments from the DIPS Registration Server and transmitting locally stored data files to the DIPS PITRS, (ii) a data fragment handling module for handling the data fragment being received for storage from the DIPS Registration Server for storage, and/or being accessed by the PITRS for reassembly during payment authorization operations, and (iii) a data storage module for storing the designated data fragments during the DIPS process of the present invention;

FIG. 5B-1 is a schematic representation of a database table schema for an exemplary embodiment of the distributed Relational Database Management System (RDBMS) realized using a four data fragment record storage nodes, wherein each said node supports an SQL database with authentication and 15 and 16 digit PIFI data fragment record tables, for credit card accounts identified by 15 and 16 digits;

FIG. 5C is a schematic representation of the DIPS Network Login Server employed on the DIPS Service Network of the present invention, illustrated in FIG. 5A, showing (i) an I/O module for interfacing with the TCP/IP infrastructure supporting the DIPS Service Network, (ii) an authentication control module for supporting authentication operations supported on the DIPS Service Network, and (iii) a data storage module for storing user profile and account related information on the DIPS Service Network;

FIG. 5D is a schematic representation of the DIPS Network Login Server employed on the DIPS Service Network of the present invention, illustrated in FIG. 5A, showing (i) an I/O module for interfacing with the TCP/IP infrastructure supporting the DIPS Service Network, an authentication control module for supporting authentication operations supported on the DIPS Service Network, and a data storage module for storing user profile and account related information on the DIPS Service Network;

FIG. 5E is a schematic representation of the DIPS PITRS employed on the DIPS Service Network of the present invention, illustrated in FIG. 5A;

FIG. 5F is a schematic representation of the system architecture of an exemplary mobile smartphone system deployed on the DIPS Service Network of the present invention and supporting the many services offered by system network servers of the present invention;

FIG. 6 is a high-level schematic process diagram illustrating the five primary services supported on the DIPS Service Network of the present invention during (i) registration of a user, and his/her smartphone and DIPS Smartphone App, (ii) registration of the user's credit card(s) and PIFI, and (iii) authorization of purchase payments over the DIPS Service Network;

FIGS. 7A-1, 7A-2 is a flow chart describing the registration of a user account on the DIPS Services Network;

FIG. 7B is a schematic illustration describing the user account registration stage supported on the DIPS Services Network of the present invention;

FIGS. 8A-1, 8A-2 is a flow chart describing the registration of a credit card (or debit card) account on the DIPS Services Network;

FIG. 8B-1 is a schematic illustration describing the credit card registration stage supported on the DIPS Services Network of the present invention;

FIG. 8B-2 is a schematic representation of exemplary PIFI data fragments stored in the database tables of each node in the four node DIPS Network Storage Network of the illustrative embodiment, supporting the DIPS Network Database (i.e. RDBMS), wherein the PIFI data fragments represent a 16 digit credit card account and exemplary user (PIFI record);

FIGS. 9A-1, 9A-2 and 9A-3 is a flow chart describing the payment authorization stage supported at an e-commerce website viewed by a registered user on a desktop or mobile computer system, having access to his/her registered smartphone on which the DIPS Smartphone App is installed;

FIGS. 9B-1, 9B-2, and 9B-3 is a flow chart describing the payment authorization process supported by the e-commerce website represented in FIG. 5A which the user is browsing using his/her smartphone, on which the DIPS Smartphone App is installed;

FIG. 9C is a schematic diagram of the e-commerce website which the user is browsing on his/her desktop, laptop computer or smartphone on which the DIPS Smartphone App is installed;

FIGS. 10A-1, 10A-2, and 10A-3 is a flow chart describing the payment authorization process supported by the POS terminal represented in FIG. 5A, before which the user is standing with his/her smartphone, on which the DIPS Smartphone App is installed;

FIG. 10B is a schematic diagram of a hybrid-commerce environment comprising a POS-terminal supported brick-and-mortar store, wherein the method of distributed identity protection is carried out at the merchant's POS-terminal using the DIPS Smartphone App of the present invention, preferably with at least one data fragment stored in a first distributed database module in of the user's registered smartphone running the DIPS Smartphone App, while other data fragments are stored on distributed database servers deployed on the DIPS Services Network, in accordance with the principles of the present invention;

FIG. 11 is a schematic representation of the AI-based multi-mode process that can be used in the DIPS Service Network of the present invention to intelligently and dynamically move data record fragments stored in the data record fragment storage nodes on the DIPS Service Network, in such a way as to provide an advantage against cyber-security threats and attacks might be waged against the DPS Service Network;

FIG. 12 is a schematic representation describing the multi-mode moving target storage service (MTSS) supported on the DIPS Service Network of the present invention illustrated in FIG. 11, shown with the PITRS, payment gateway system, user and mobile computing device with mobile app, a POS terminal, and e-ecommerce site and store, wherein the MTSS Controller is programmed to enter any one of multiple possible modes of data record fragment movement and/or rearrangement (i.e. M1, M2, M3, M4 and M5) on the DIPS Database Network, in response to the occurrence of particular events on the DIPS Service Network being continuously monitored by the MTSS Controller;

FIG. 12A is a flow chart describing the primary steps carried out by the multi-mode MTSS Controller when entering the first Mode #1 of data record fragment movement triggered by a PITRS/User event, which occurs each time a payment authorization transaction (e.g. payment approved or denied) is carried out using the DIPS Service Network of the present invention;

FIG. 12B is a flow chart describing the primary steps carried out by the multi-mode MTSS Controller when entering the second Mode #2 of data record fragment movement triggered by a timestamp event, namely that the PIFI data record fragments associated with a specific PIFI data record, have been determined to be stored at specific node locations, beyond the predetermined time threshold period, and require automated movement by the MTSS Controller;

FIG. 12C is a flow chart describing the primary steps carried out by the multi-mode MTSS Controller when entering the third Mode #3 of data record fragment movement triggered by an admin event, requesting MTSS Controller to remove a specified registered Data Record Fragment Storage Node from the DIPS service network;

FIG. 12D is a flow chart describing the primary steps carried out by the multi-mode MTSS Controller when entering the fourth Mode #4 of data record fragment movement triggered by an admin event, requesting from MTSS Controller to move and rearrange all PIFI Data Record Fragments on a particular data record storage node;

FIG. 12E is a flow chart describing the primary steps carried out by the multi-mode MTSS Controller when entering the fifth Mode #5 of data record fragment movement—static and always running to make certain that multiple PIFI data fragments associated with a particular PIFI data record are not stored on the same data record fragment storage node on the DIPS Service Network, and if so, then to automatically move the other data record fragments to ensure that each linked data record fragment is stored on a different and independent node on the DIPS network;

FIG. 13A is a set of exemplary database tables maintained at four data record fragment storage nodes on the DIPS Service Network being managed by the multi-mode MTSS Controller of the present invention; and

FIG. 13B is a set of exemplary database tables maintained at four data record fragment storage nodes on the DIPS Service Network, illustrated in FIG. 13A, after the PIFI data record fragments have been moved to other nodes on the storage network, and one node has been emptied of all PIFI data record fragments matching a dips map character string, used to identify where each unique set of PIFI data record fragments are stored on the DIPS Service Network.

### DETAILED DESCRIPTION OF THE ILLUSTRATIVE EMBODIMENT OF THE PRESENT INVENTION

Referring to the accompanying Drawings, like structures and elements shown throughout the figures thereof shall be indicated with like reference numerals.

Specification of a Three Storage Node Distributed Identity Protection System (DIPS) Services Network of the Present Invention Supporting a Merchant's E-Commerce Store and/or Brick-And-Mortar Store Equipped with One or More POS Terminals

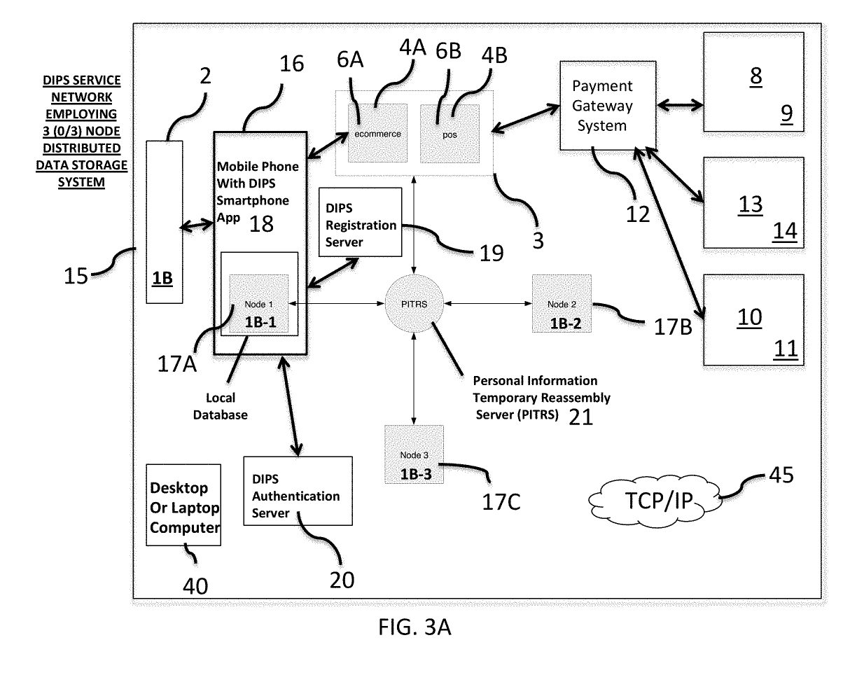

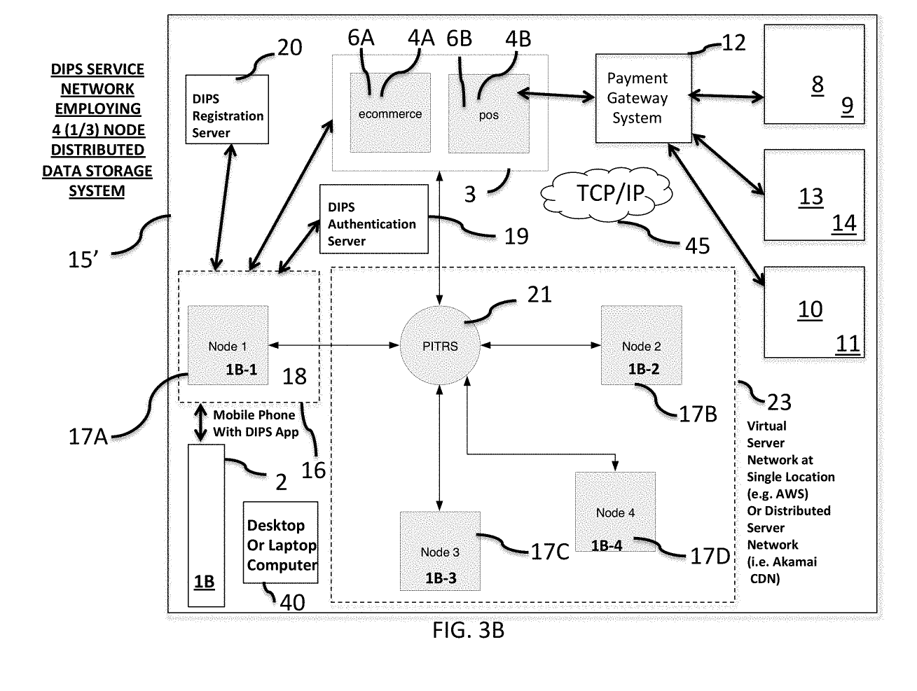

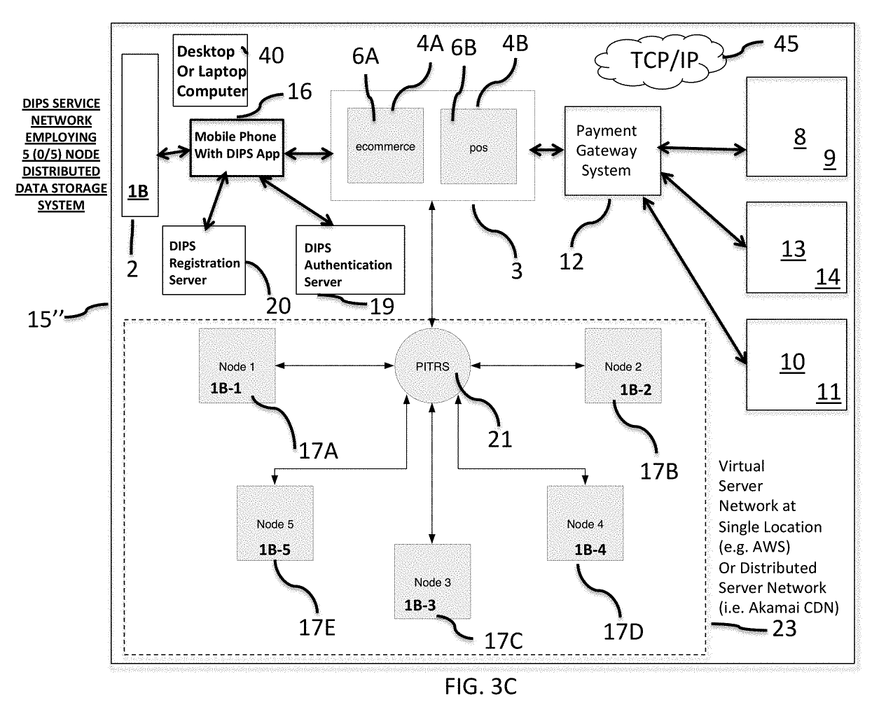

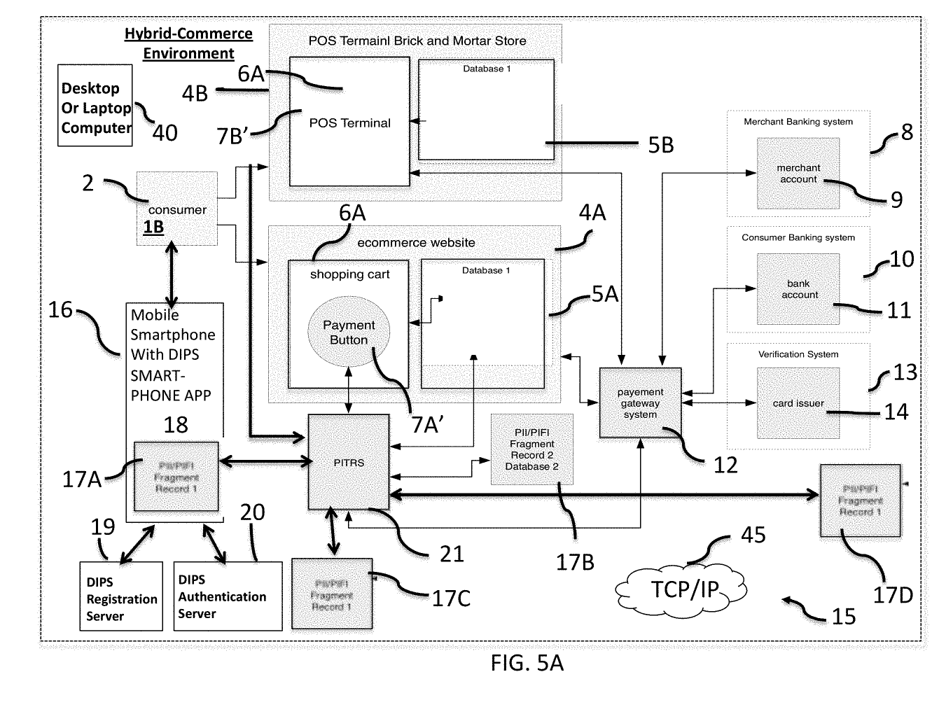

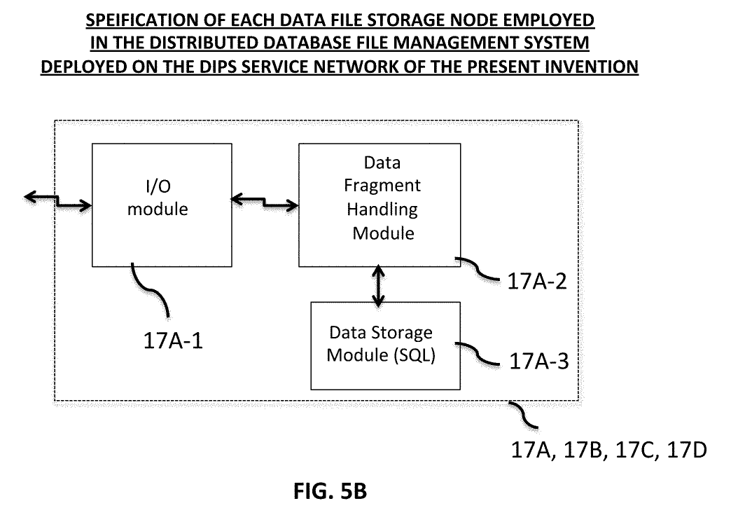

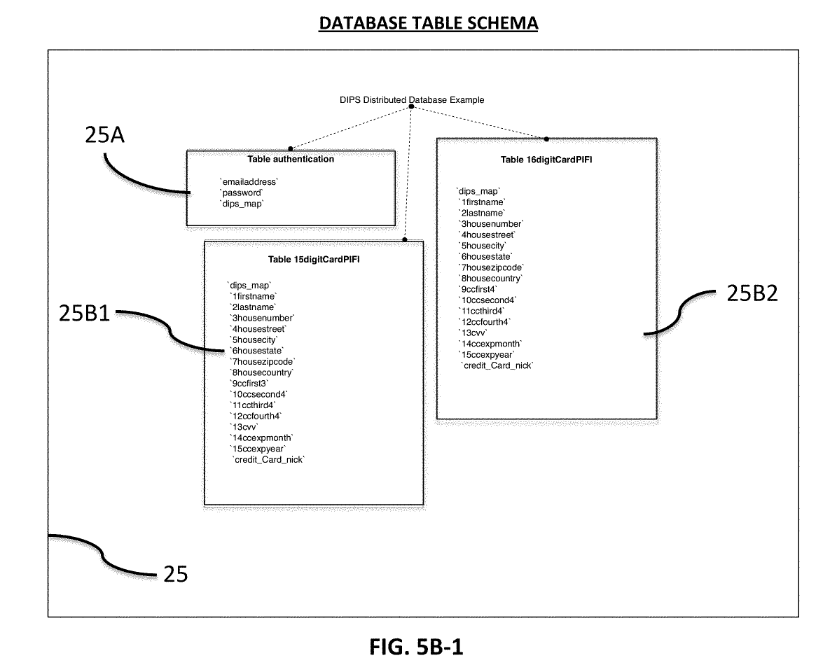

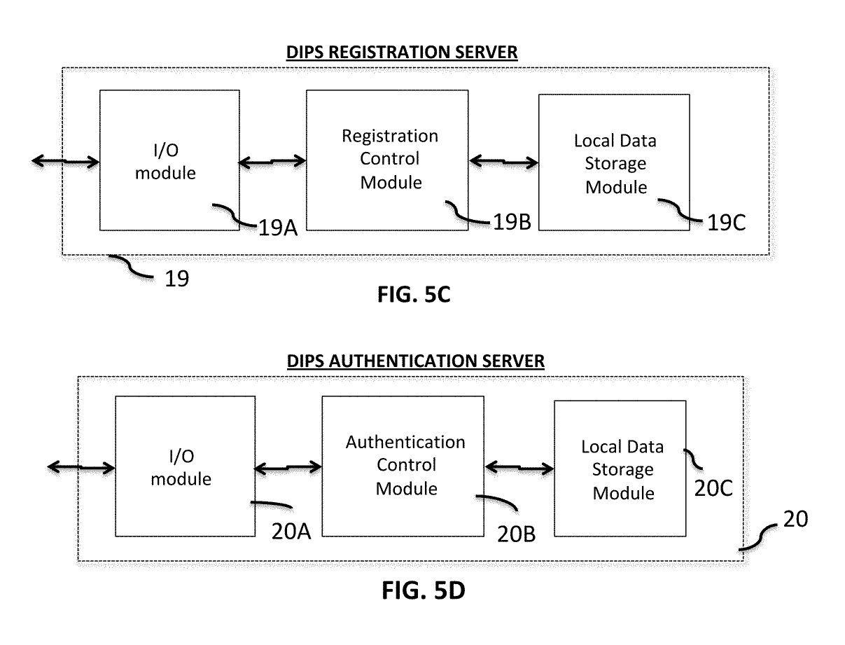

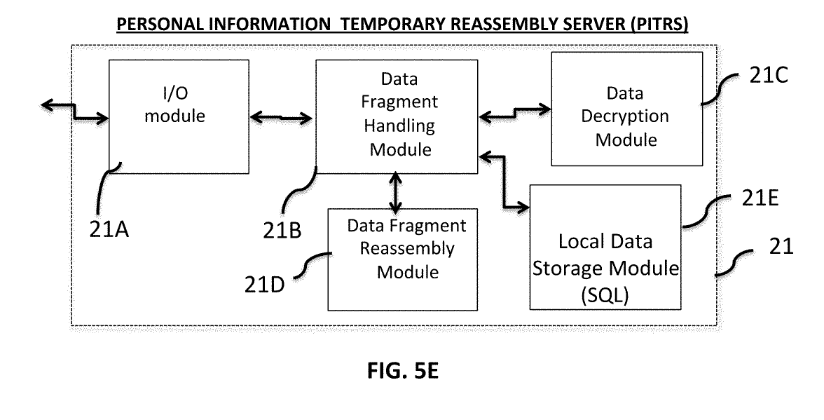

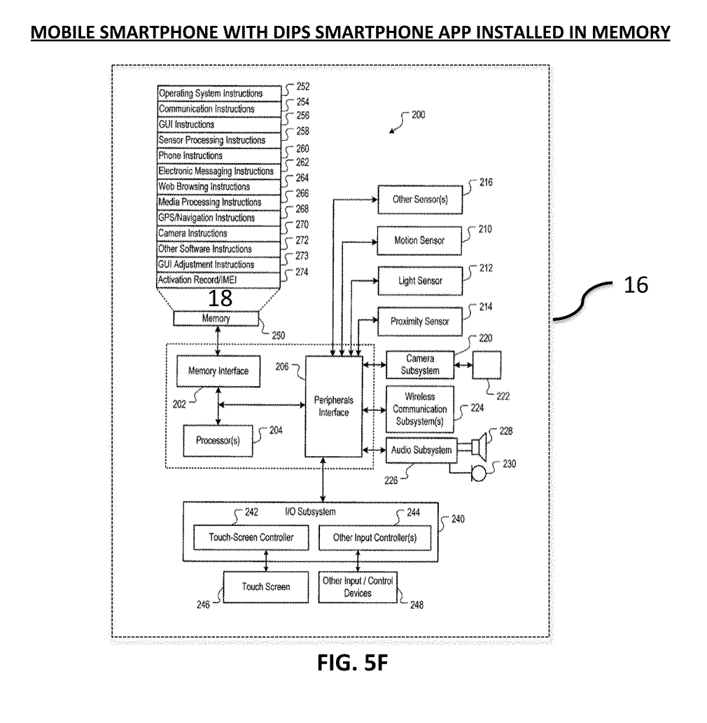

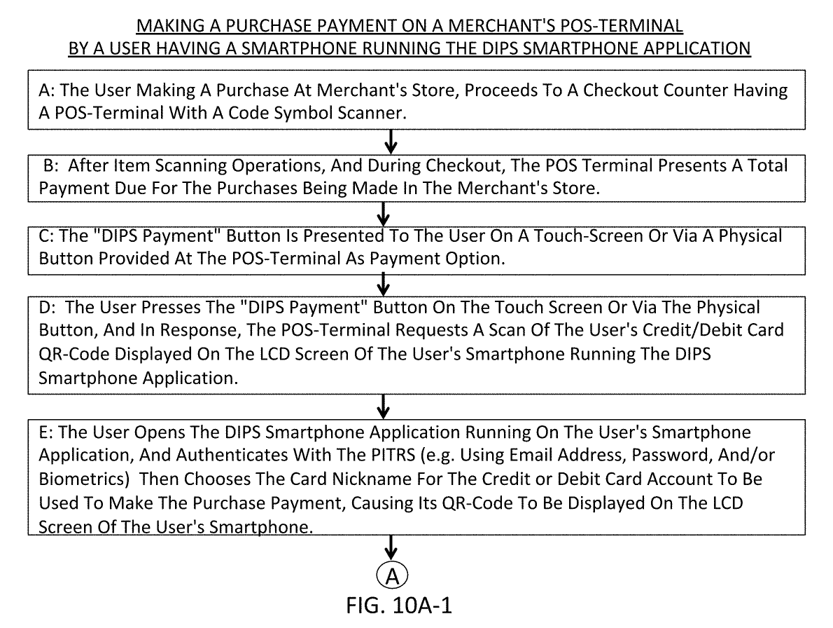

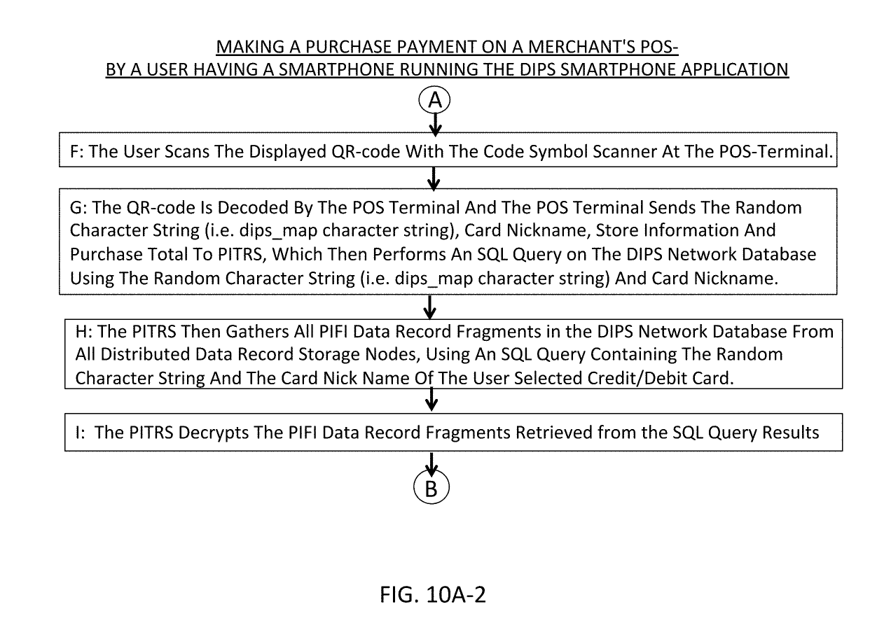

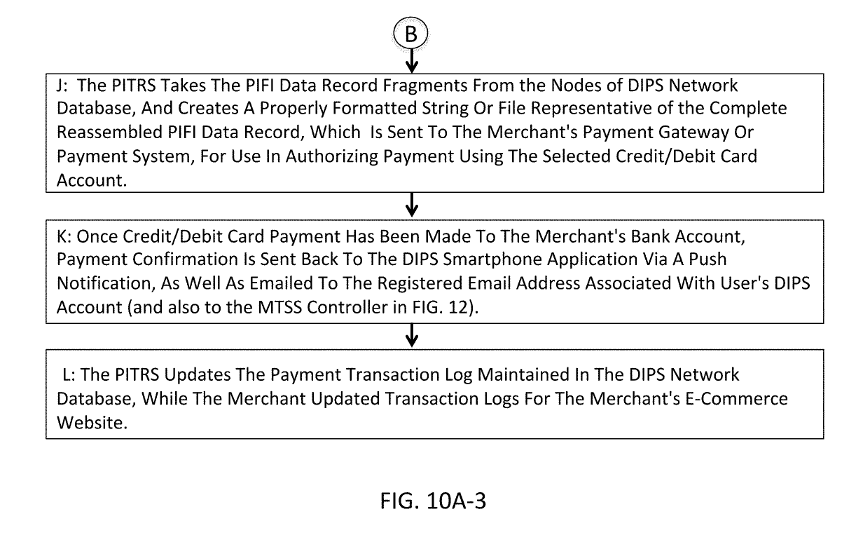

FIG. 3A shows a first illustrative embodiment of the DIPS Service Network 15 of the present invention. As shown, the DIPS Service Network 15 supports and serves a merchant's hybrid-commerce network 3 comprising an e-commerce website and online store 4A with an electronic shopping cart 6A for payment authorization, and/or a brick-and-mortar store 4B equipped with one or more POS terminals 6B also for payment authorization. The shopping cart 6A is provided with a check-out/payment button 7A′ and is operably connected to a payment gateway system 12 for payment authorization. As shown in FIGS. 5A and 10B, in greater detail, the POS terminal 6B is provided with an optical code symbol reader 6C for reading QR-code symbols 25 displayed on the LCD panel of the consumer's mobile computing device 16 (e.g. a smartphone such as Apple iPhone running IOS, or a Samsung smartphone running Android OS, or tablet computer such as an Apple® iPad, or other mobile computing device) during the practice of the present invention, and for other purposes at the retail POS station. As shown, the payment gateway system 12 provides access to numerous systems including a verification system 14 supported by a card issuer 13, a merchant banking system 8 supporting a merchant bank account 9, and a consumer banking system 10 supporting a consumer bank account 13. All client and server computer systems deployed on the DIPS Service Network 15 of the present invention, including the consumer's mobile smartphone device 16 and desktop, laptop, and tablet computer 40 and DIPS servers 19, 20, and 21, are operably connected to the TCP/IP infrastructure of the Internet 50, through physical and/or wireless link connections, in a manner well known in the networking and data communications art.

As shown in the illustrative embodiment of FIG. 3A, the DIPS Services Network 15 employs a three (3) storage node network 17 and supports the DIPS process comprising: (i) automatically fragmenting user personally-identifiable financial information (PIFI) files 1B into three (3) data fragments; (ii) storing the three data fragments 1B-1, 1B-2 and 1B-3 in three (3) geographically/network-distributed data servers (i.e. storage nodes), 17A, 17B and 17C, respectively, on the DIPS Service Network 15; (iii) the PITRS 21 automatically and temporarily recombining these three (3) data fragments into a complete PIFI data string (1B), then using the complete PIFI data string 1B recombined by PITRS 21 to authorize credit and/or debit card issuers 13 to pay merchant banks 8 from consumer banks 10 for purchases on behalf of consumers 2, through the payment gateway system 12, and thereafter automatically destroying the recombined PIFI data string to protect and secure the PIFI record, after completion of payment authorization; and (iv) executing financial payment transactions between a consumer's bank account 10 and the bank account 9 maintained by the merchant bank 8 on behalf of the merchant, from whom the consumer 2 is purchasing goods and/or services in accordance with the principles of the present invention.

Specification of a Four Storage Node Distributed Identity Protection System (DIPS) Services Network of the Present Invention Supporting a Merchant's E-Commerce Store and/or Brick-And-Mortar Store Equipped with One or More POS Terminals

FIG. 3B shows a second illustrative embodiment of the DIPS Services Network 15′ of the present invention. As shown, the DIPS Service Network 15′ supports and serves a merchant's hybrid-commerce network 3 comprising an e-commerce store 4A with an electronic shopping cart 6A, and/or a brick-and-mortar store 4B equipped with one or more POS terminals 6B. As shown in FIG. 3B, the DIPS Services Network 15′ employs a 4 storage node network and supports a DIPS process comprising: (i) automatically fragmenting user PIFI files 1B into four (4) data fragments 1B-1, 1B-2, 1B-3 and 1B-4; (ii) storing the three data fragments in four (4) geographically/network-distributed data servers (i.e. storage nodes) 17A, 17B, 17C and 17D on the DIPS Service Network 15′; (iii) the PITRS 21 automatically and temporarily recombining these four (4) data fragments 1B-1, 1B-2, 1B-3 and 1B-4 into a complete PIFI data string (1B), then using the complete PIFI data string 1B recombined by PITRS 21 to authorize credit and/or debit card issuers 13 to pay merchant banks 8 from consumer banks 10 for purchases on behalf of consumers 2, through the payment gateway system 12, and thereafter automatically destroying the recombined PIFI data string to protect and secure the PIFI record, after completion of payment authorization; and (iv) executing financial payment transactions between a consumer's bank account 10 and the bank account 9 maintained by the merchant bank 8 on behalf of the merchant, from whom the consumer 2 is purchasing goods and/or services in accordance with the principles of the present invention. All client and server computer systems deployed on the DIPS Service Network 15′ of the present invention, including the consumer's mobile smartphone device 16 and desktop, laptop, and tablet computer 40 and DIPS servers 19, 20, and 21, are operably connected to the TCP/IP infrastructure of the Internet 50, through physical and/or wireless link connections, in a manner well known in the networking and data communications art.

Specification of a Five Storage Node Distributed Identity Protection System (DIPS) Services Network of the Present Invention Supporting a Merchant's E-Commerce Store and/or Brick-And-Mortar Store Equipped with One or More POS Terminals

FIG. 3B shows a third illustrative embodiment of the DIPS Services Network of the present invention 15″. As shown, the DIPS Service Network 15″ supports and serves a merchant's hybrid-commerce network 3 comprising an e-commerce store 4A with an electronic shopping cart 6A, and/or a brick-and-mortar store 4B equipped with one or more POS terminals 6B. As shown in FIG. 3B, the DIPS Services Network 15′ employs a five (5) storage node network 17A, 17B, 17C, 17D and 17E and supports a DIPS process comprising: (i) automatically fragmenting user personally-identifiable financial information (PIFI) files 1B into five (5) data fragments 1B-1, 1B-2, 1B-3, 1B-4 and 1B-5; (ii) storing each set of five data fragments in five (5) geographically/network-distributed data servers (i.e. storage nodes) 17A, 17B, 17C, 17D and 17E deployed on the DIPS Service Network 15″; (iii) the PITRS 21 automatically and temporarily recombining these five (5) data fragments 1B-1, 1B-2, 1B-3, 1B-4 and 1B-5 into a complete PIFI data string (1B), then using the complete PIFI data string 1B recombined by PITRS 21 to authorize credit and/or debit card issuers 13 to pay merchant banks 8 from consumer banks 10 for purchases on behalf of consumers 2, through the payment gateway system 12, and thereafter automatically destroying the recombined PIFI data string to protect and secure the PIFI record, after completion of payment authorization; and (iv) executing financial payment transactions between a consumer's bank account 10 and the bank account 9 maintained by the merchant bank 8 on behalf of the merchant, from whom the consumer 2 is purchasing goods and/or services in accordance with the principles of the present invention. All client and server computer systems deployed on the DIPS Service Network 15″ of the present invention, including the consumer's mobile smartphone device 16 and desktop, laptop, and tablet computer 40 and DIPS servers 19, 20, and 21, are operably connected to the TCP/IP infrastructure of the Internet 50, through physical and/or wireless link connections, in a manner well known in the networking and data communications art.

### Specification of the DIPS Process on the DIPS Service Network of the Present Invention and Method of PIFI Record Fragmentation, Encryption and Distributed Storage

In general, the PIFI records 1B of consumers registered on the DIPS Service Network (15, 15′, 15″) are automatically analyzed, fragmented, distributed and stored during the credit/debit card registration process; and then these PIFI data record files 1B-1, 1B-2, 1B-3, 1B-4 etc. are automatically and temporarily recombined as a complete PIFI data string, and transmitted through the payment gateway system 12 to the credit/debit card issuers 14 for payment authorization, and immediately thereafter, thereafter the temporary PIFI data string is automatically destroyed to preserve and secure the PIFI records on the DIPS Service Network 15.

More specifically, during the credit and or debit card registration process supported by the DIPS Service Network, the user's PIFI record 1B is automatically fragmented into multiple data fragments 1B-1, 1B-2, 1B-3, 1B-4 etc. These multiple data fragments are then stored in multiple geographically/network distributed data servers (i.e. storage nodes) 1A, 17B, 17C, 17D etc. on the DIPS Service Network 15.

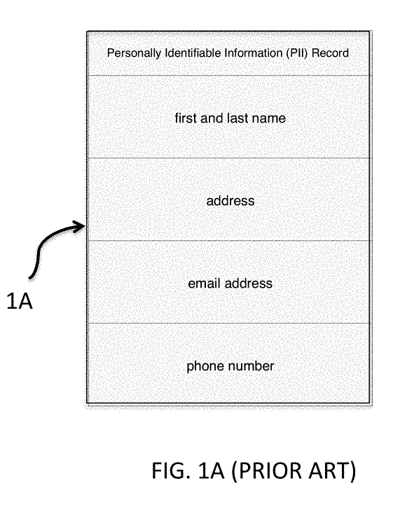

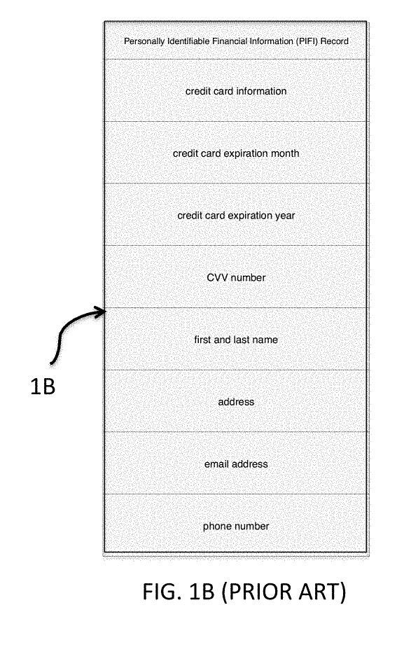

Then, during the payment authorization process supported by the DIPS Service Network 15, as illustrated in FIGS. 9A-1, 9A-2, 9A-3, and 9B-1, 9B-2 and 9B-3, and 10A-1, 10A-2 and 10A-3, the consumer requests payment from a credit/debit card registered on the DIPS Service Network. In response to the request for payment authorization, the PITRS 21 automatically and temporarily accesses the multiple data fragments 1B-1, 1B-2, 1B-3, 1B-4 stored across distributed network of data storage servers, and recombines these retrieved PIFI data record file fragments into a complete PIFI data string. This complete PIFI data string is then used to authorize credit and debit card issuers 14 through the payment gateway system 12, and then automatically destroys the recombined PIFI data string to protect and secure the PIFI record. Then, the financial payment transaction is executed between the consumer's bank account 11 and the merchant's bank account 9, from whom the consumer is purchasing goods and/or services.

When carrying out the DIPS based payment authorization method of the present invention, the financial payment request that drives the process described above may stem from any kind of transaction in commerce involving the purchase or leasing of goods and/or services. Also, while the consumer's PIFI record 1B is automatically and transparently decomposed into multiple PIFI data fragments 1B-1, 1B-2, 1B-3, 1B-4 etc, and stored in the directories of the distributed network of data storage servers 17A, 17B, 17C, 17D etc. deployed on the DIPS Server Network 15, 15′, 15″, it is understood that the consumer's PIFI record 1B, unique for each credit or debit account, can be fragmented into any number of PIFI data fragments and stored on the same number of distributed storage servers, during credit/debit card registration process.

While these data record fragment files will typically be stored in SQL-type relational database management systems (RDBMS) as disclosed herein and well known in the art, such data record fragment files may, alternatively, be stored in non-relational distributed data storage systems such as Hadoop® by Apache. Such data stores 17A, 17, 17C, 17D etc. can be supported on a set of remotely-located individual information servers, each running its own operating system, and having its own CPUs and memory drives. Alternatively, the data stores 17A, 17, 17C, 17D etc. can be (i) supported on a cloud infrastructure maintained at a single location, such as Amazon Web Services (AWS) or (ii) supported on a distributed server network, across many different locations, such as Akamai's Content Delivery Network (CDN) 23, as illustrated in FIGS. 3B and 3C.

Specification of the DIPS Service Network and Method of Making Purchase Payments for a Consumer Purchase Transaction for Goods and/or Services at a Merchant's E-Commerce and/or Brick and Mortar Store

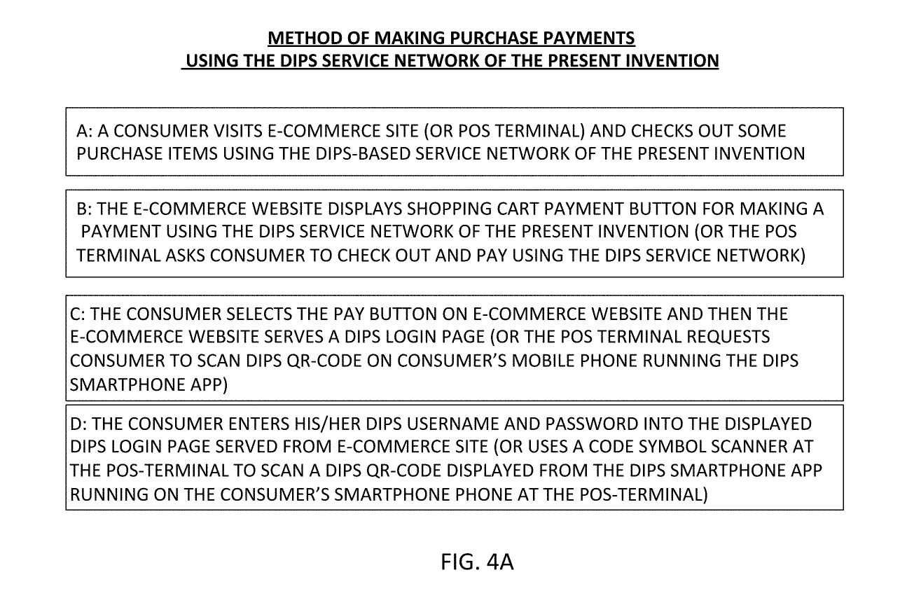

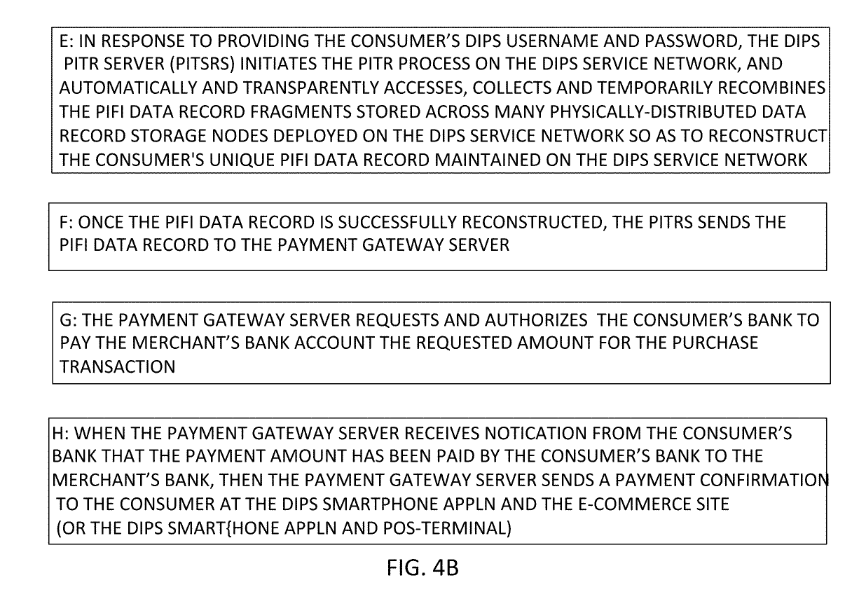

As shown in FIGS. 4A and 4B, a generalized method of PIFI protection is described for use on the DIPS Service Network, when a consumer is making purchase payments for a consumer purchase transaction for goods and/or services at a merchant's e-commerce site 4A and/or brick and mortar store 4B. The details of this method will be described below.

As indicated at Block A in FIG. 4A, a consumer visits e-commerce site 6A, or POS terminal 6B and checks out some item purchases using the DIPS Service Network.

As indicated at Block B in FIG. 4A, the e-commerce website 4A displays shopping cart payment button 7B′ for making a payment using the DIPS Service Network of the present invention or the POS-terminal 6B requests the consumer to check out and pay using the DIPS Service Network.

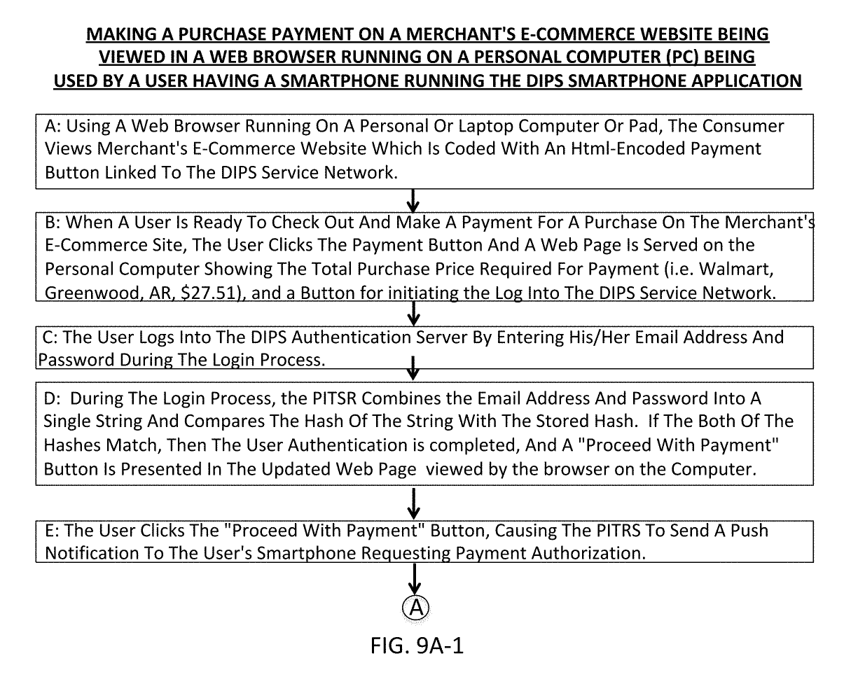

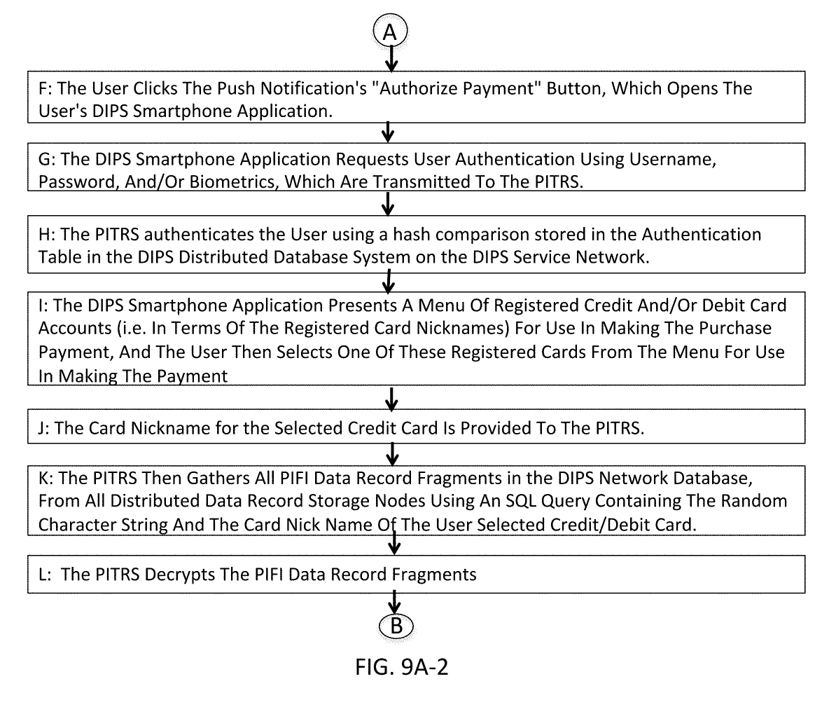

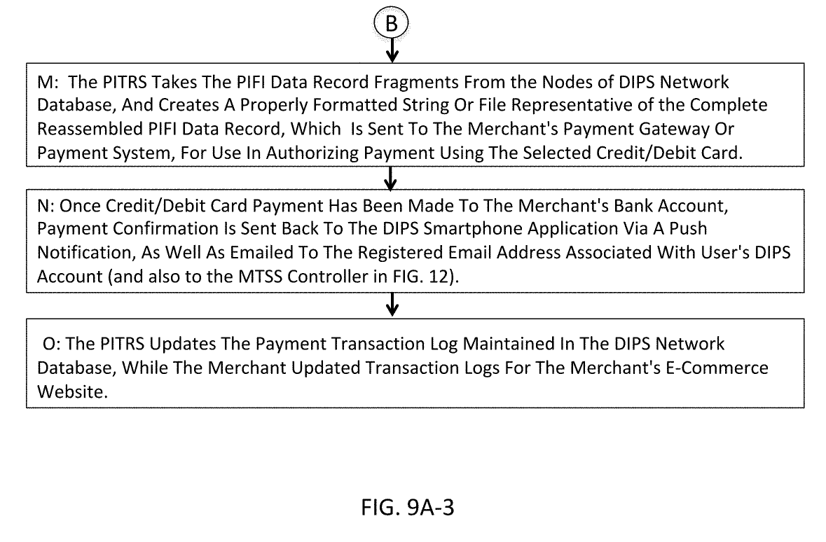

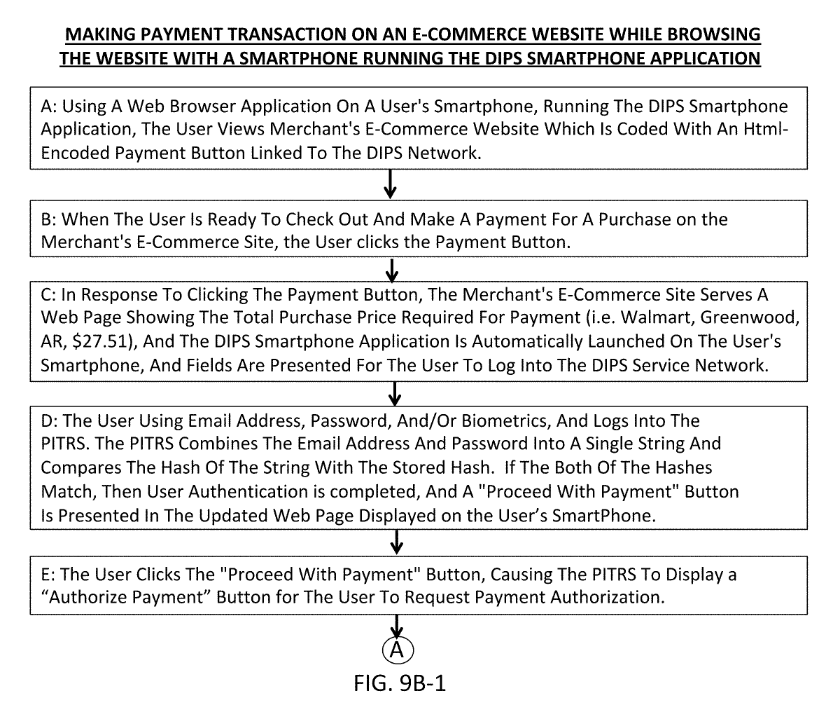

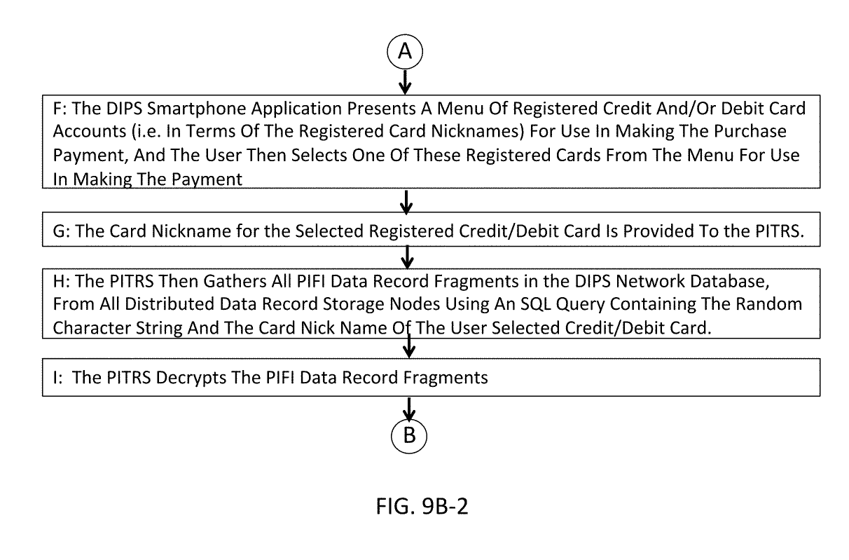

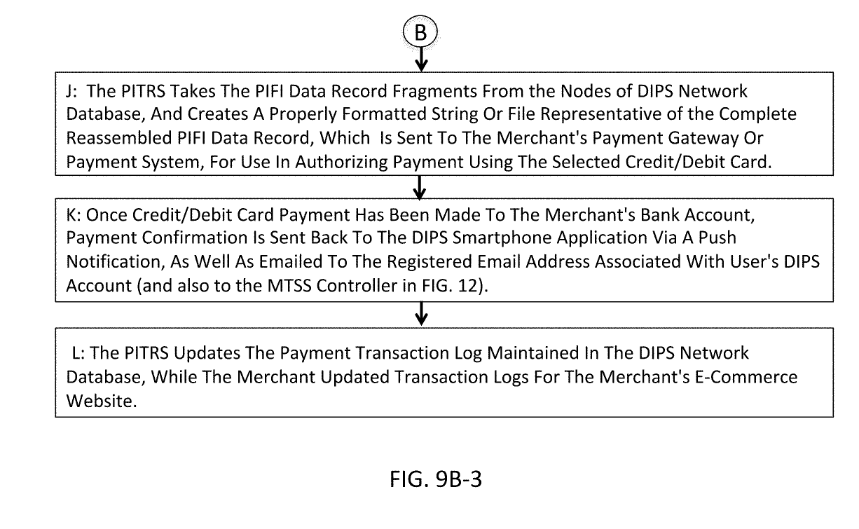

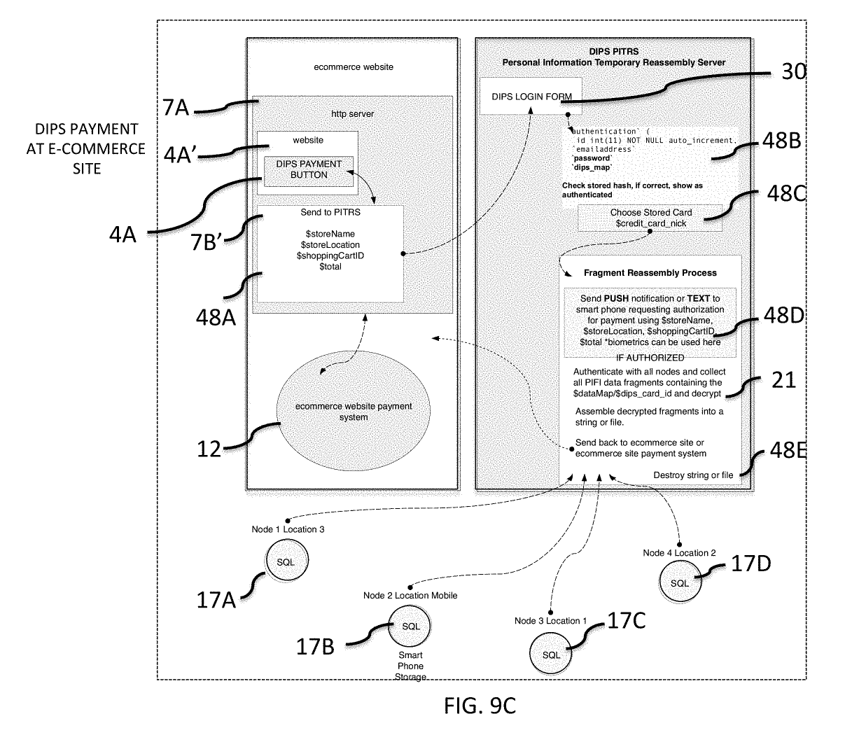

As indicated at Block C in FIG. 4A, the consumer selects the pay button on e-commerce website 4A and then the e-commerce website serves a DIPS login page 30 (see FIG. 9C), or the POS terminal 6B requests consumer to scan a DIPS QR-code symbol 25 displayed on the LCD panel of the consumer's mobile smartphone device 16 (e.g. Apple® iPhone 6 system) running the DIPS Smartphone App 18.

As indicated at Block D in FIG. 4A, the consumer enters his/her DIPS username and password into the displayed DIPS Network login page served from e-commerce site, or uses an optical code symbol scanner 6C at the POS-terminal 6B to scan a DIPS QR-Code 25 displayed from the DIPS Smartphone App 18 running on the consumer's Smartphone device 16 at the POS-terminal 13.

As indicated at Block E in FIG. 4B, in response to providing the consumer's DIPS username and password, the DIPS PITRS 21 initiates the PITR process on the DIPS Service Network 15, 15′ and 15″, and automatically and transparently accesses, collects and temporarily recombines the DIPS data record fragments stored across many physically-distributed data record storage nodes 17A, 17B, 17C, 17D etc. deployed on the DIPS Service Network so as to reconstruct the consumer's unique PIFI data record 1B maintained on the DIPS Service Network.

As indicated at Block F in FIG. 4B, once the PIFI data record is successfully reconstructed, the PITRS 21 sends the PIFI data record through the payment gateway 12 to the payment authentication server 19 requesting payment authorization and payment.

As indicated at Block G in FIG. 4B, the payment gateway server 12 requests and authorizes the consumer's bank 8 to pay the merchant's bank account 9 the requested amount for the purchase transaction.

As indicated at Block H in FIG. 4B, when the payment gateway server 12 receives notification from the consumer's bank that the payment amount has been made to the merchant's bank, then the payment gateway server 12 sends a payment confirmation to the consumer at the DIPS Smartphone App 18 and e-commerce site (or the DIPS Smartphone App and POS-Terminal).

### Specification of a Hybrid-Commerce Environment Supporting a Four (4) Node DIPS Service Network According to the Present Invention

FIG. 5A shows a hybrid-commerce environment supporting a four (4) node DIPS Service Network according to the present invention, as illustrated in FIG. 3B comprising: a POS-terminal 6B supported in brick-and-mortar store 4B; an e-commerce website 4A; a Registration Server 20 for registering new users and creating new User Accounts on the DIPS Services Network, and registering credit cards and debit cards to registered users on the DIPS Service Network; an DIPS Authentication Server 19 for network login purposes; a PITRS 21 for supporting user authentication like server 19, and also for transparently accessing PIFI data record fragments (1B-1, 1B-2, 1B3, 1B4) stored in database tables of the nodes of a distributed network of data record storage nodes 17A, 17B, 17C, 17D supported on the DIPS Service Network; and a plurality of mobile computing devices including smartphones, Apple iPads, tablet computers, Android devices etc 16 (for a plurality of registered consumers 2), each having the DIPS smartphone application 18 installed and running on its mobile computing platform.

As shown in FIG. 5A, the e-commerce website 4A comprises: webpages supporting a shopping cart 6A with a check-out/payment button 7A′ that is operably connected to the merchant's payment gateway system 12. As shown, the brick-and-mortar store 4B comprises: a store with one or more POS terminals 6B for payment authorization. Each POS terminal 6B is interfaced to an optical code symbol scanner for scanning/reading a DIPS QR-Code 25 displayed from the LCD panel of the consumer's Smartphone device 16 running the DIPS Smartphone App 18, and operably connected to the payment gateway system 12. The payment gateway system 12 provides access to numerous systems including: the verification system 13 supported by the card issuer 14; the merchant banking system 8 supporting the merchant bank account 9; and the consumer banking system 10 supporting the consumer bank account 11.

### Specification of the Distributed Data Storage Module Used as a Node in the DIPS Service Network of the Present Invention

FIG. 5B shows a Distributed Data Storage Module 17A (17B, 17C, 17D, 17E) used as a node in the distributed data record storage network 17 supported by the DIPS Service Network 15, 15′, 15″ of the present invention. As shown, each Distributed Data Storage Module comprises: (i) an I/O module 17A-1 for interfacing with the TCP/IP infrastructure supporting the DIPS Service Network, receiving encrypted data fragments from the DIPS Registration Server 19 and transmitting locally stored data files to the DIPS PITRS 21; (ii) a data fragment handling module 17A-2 for handling the data fragment being received for storage from the Registration Server 19 for storage, and/or being accessed by the PITRS 21 for reassembly during payment authorization operations; and (iii) a local data storage module 17A-3 for storing the designated data fragments during the DIPS process of the present invention.

### Specification of the DIPS Registration Server Employed on the DIPS Service Network of the Present Invention

FIG. 5C shows the DIPS Registration Server 19 employed on the DIPS Service Network, illustrated in FIG. 5A, comprising: (i) an I/O module 19A for interfacing with the TCP/IP infrastructure supporting the DIPS Service Network; (ii) a registration control module 19B for supporting registration operations supported on the DIPS Service Network; and (iii) a local data storage module 20C for storing limited user profile and account related information on the DIPS Service Network.

During the operation of the DIPS Service Network of the present invention, the Registration Server 19 will maintain a current list of all active and inactive/removed PIFI data record fragment storage nodes (e.g. 17A, 17B, 17C, 17D, etc) deployed on DIPS Service Network. Data Record Fragment Storage Nodes will be added to and removed from this Active Data Record Fragment Storage Node Registration List over time, and this node registration list will be used by the Registration Server each time a credit or debit card account is registered on the DIPS Service Network, and a set of data record fragment storage nodes are selected for initially storing the set of PIFI data record fragments linked to the PIFI data record created by the user requesting to register his or her credit or debit card account on the DIPS Service Network.

### Specification of the DIPS Network Authentication Server Employed on the DIPS Service Network of the Present Invention

FIG. 5D shows the DIPS Network Authentication (i.e. Login) Server 20 employed on the DIPS service network, illustrated in FIG. 5A, comprising: (i) an I/O module 20A for interfacing with the TCP/IP infrastructure supporting the DIPS Service Network; an authentication control module 20B for supporting authentication operations supported on the DIPS Service Network; and a data storage module 20C for storing user profile and account related information on the DIPS Service Network.

### Specification of the DIPS Personal Information Temporary Reassembly Server (PITRS) Employed on the DIPS Service Network of the Present Invention

FIG. 5E shows the DIPS PITRS 21 employed on the DIPS Service Network of the present invention, illustrated in FIG. 5A, comprising: (i) an I/O module 21A for interfacing with the TCP/IP infrastructure supporting the DIPS Service Network, receiving requests for encrypted data fragments from the DIPS PITRS and transmitting locally stored data files to the DIPS PITRS 21; (ii) a data fragment handling module 21B for handling the data fragments being accessed by the PITRS 21 for reassembly during payment authorization operations; a (ii) a data decryption module 21C for data decryption operations; (iv) a data fragment reassembly module 21D for recombining accessed data fragments during the data fragment file reassembly process of the present invention; and (iv) a local data storage module 21E for buffering the data fragments being accessed by the PITRS 21 during the DIPS process of the present invention.

### Specification of System Architecture of an Exemplary Mobile Smartphone System Deployed on the DIPS Service Network of the Present Invention

FIG. 5F shows the system architecture of an exemplary mobile smartphone system (e.g. client device) 16 that is deployed on the DIPS Service Network of the present invention and supporting the many services offered by system network servers of the present invention. As shown, the mobile smartphone device 16 can include a memory interface 202, one or more data processors, image processors and/or central processing units 204, and a peripherals interface 206. The memory interface 202, the one or more processors 204 and/or the peripherals interface 206 can be separate components or can be integrated in one or more integrated circuits. The various components in the mobile device can be coupled by one or more communication buses or signal lines. Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions. Other sensors 216 can also be connected to the peripherals interface 206, such as a positioning system (e.g. GPS receiver), a temperature sensor, a biometric sensor, a gyroscope, or other sensing device, to facilitate related functionalities. A camera subsystem 220 and an optical sensor 222, e.g. a charged coupled device (CCD) or a complementary metal-oxide semiconductor (CMOS) optical sensor, can be utilized to facilitate camera functions, such as recording photographs and video clips. Communication functions can be facilitated through one or more wireless communication subsystems 224, which can include radio frequency receivers and transmitters and/or optical (e.g. infrared) receivers and transmitters. The specific design and implementation of the communication subsystem 224 can depend on the communication network(s) over which the mobile device 8B, 8C is intended to operate. For example, a mobile device 100 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the device 100 may be configured as a base station for other wireless devices. An audio subsystem 226 can be coupled to a speaker 228 and a microphone 230 to facilitate voice-enabled functions, such as voice recognition, voice replication, digital recording, and telephony functions. The I/O subsystem 240 can include a touch screen controller 242 and/or other input controller(s) 244. The touch-screen controller 242 can be coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246. The other input controller(s) 244 can be coupled to other input/control devices 248, such as one or more buttons, rocker switches, thumb-wheel, infrared port, USB port, and/or a pointer device such as a stylus. The one or more buttons (not shown) can include an up/down button for volume control of the speaker 228 and/or the microphone 230. Such buttons and controls can be implemented as a hardware objects, or touch-screen graphical interface objects, touched and controlled by the system user. Additional features of mobile smartphone device 16 can be found in U.S. Pat. No. 8,631,358 incorporated herein by reference in its entirety.

### Specification of the Primary Services Supported on the DIPS Service Network of the Present Invention

FIG. 6 illustrates five primary services supported on the DIPS Service Network during (i) registration of a user and his/her smartphone and DIPS Smartphone App 18 on the DIPS Service Network 15, 15′, 15″, (ii) registration of the user's credit cards and personally identifiable financial information (PIFI) record 1B on the DIPS Service Network, and (iii) authorization of purchase payments from the consumer's credit and/or debit accounts over the DIPS Service Network.

Specifically, FIGS. 7A-1 and 7A-2 describe services for registering user account and Smartphone/Smartphone Apps (16,18).

FIGS. 8A-1 and 8A-2 describe services for registration of consumer credit/debit card accounts.

FIGS. 9A-1 and 9A-2 describe services for authorization of e-commerce purchase payments for transactions conducted on a desktop or mobile computer system 40, wherein the user's smartphone 16, with the DIPS Smartphone App 18 installed thereon, on is available and used for requesting and receiving such payment authorization services.

FIGS. 9B-1 and 9B-2 describe services for authorization of e-commerce purchase payments for transactions conducted on the user's Smartphone 16, on which the DIPS Smartphone App 18 is installed.

FIGS. 9A-1 and 9A-2 describe services for authorization of purchase payments for transactions conducted at a brick & mortar store 4B before POS-terminal 6B with code symbol scanner 6C, using the user's mobile smartphone 16 with the DIPS Smartphone App 18 installed thereon, wherein such payment authorization services can be initiated by scanning QR-code symbols displayed on the LCD panel of the user's mobile smartphone 16 running the DIPS Smartphone App 18.

These services will be described in greater detail hereinafter.

### Specification of the Method of Registering a User on the DIPS Services Network of the Present Invention

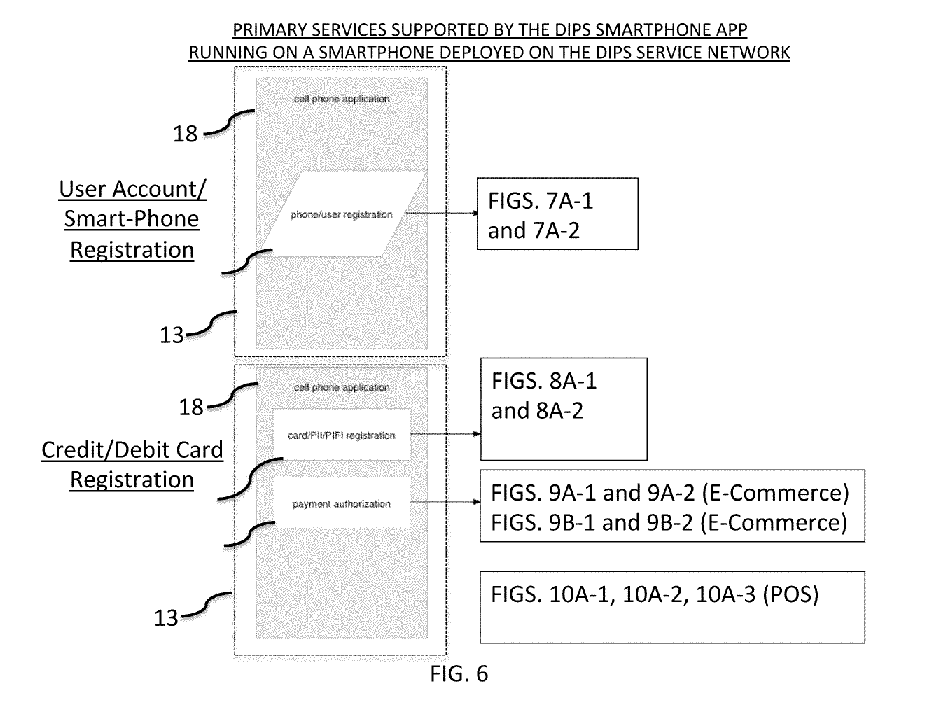

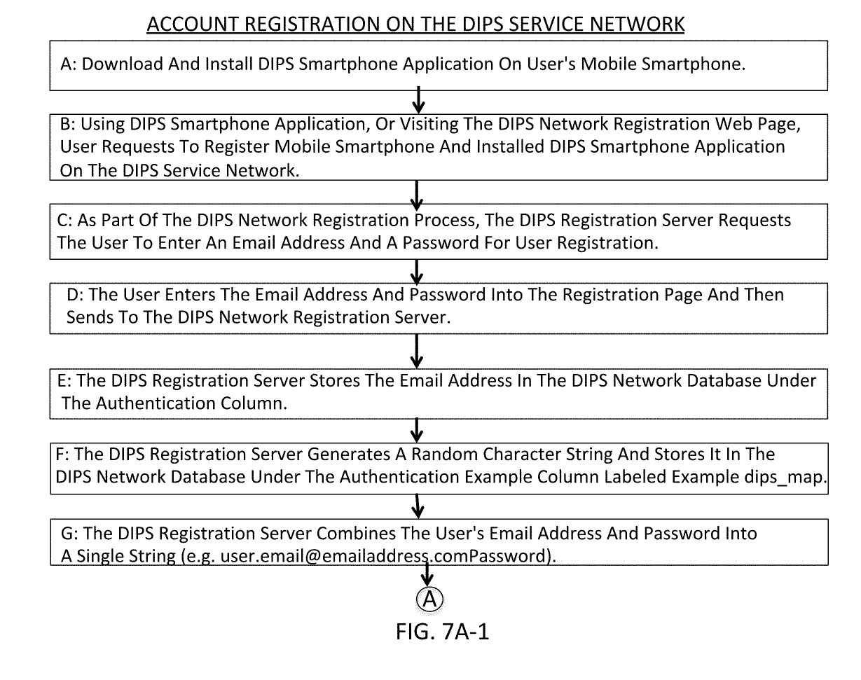

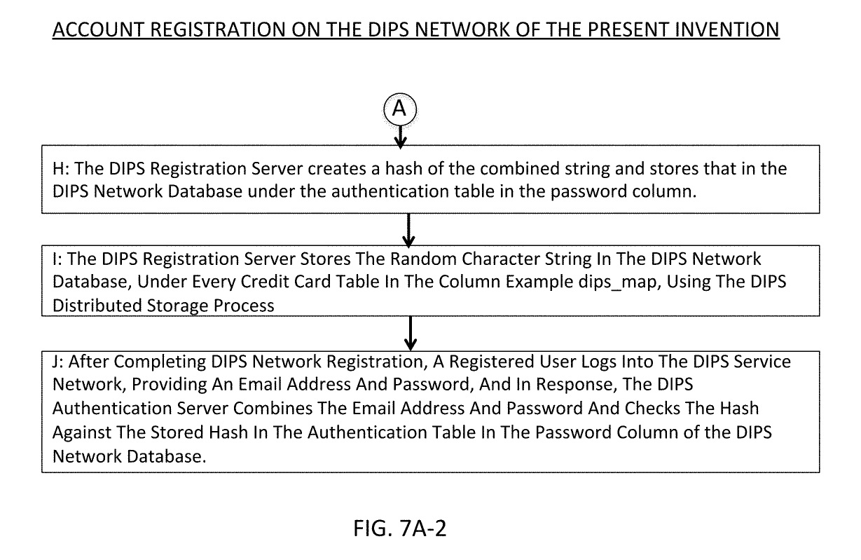

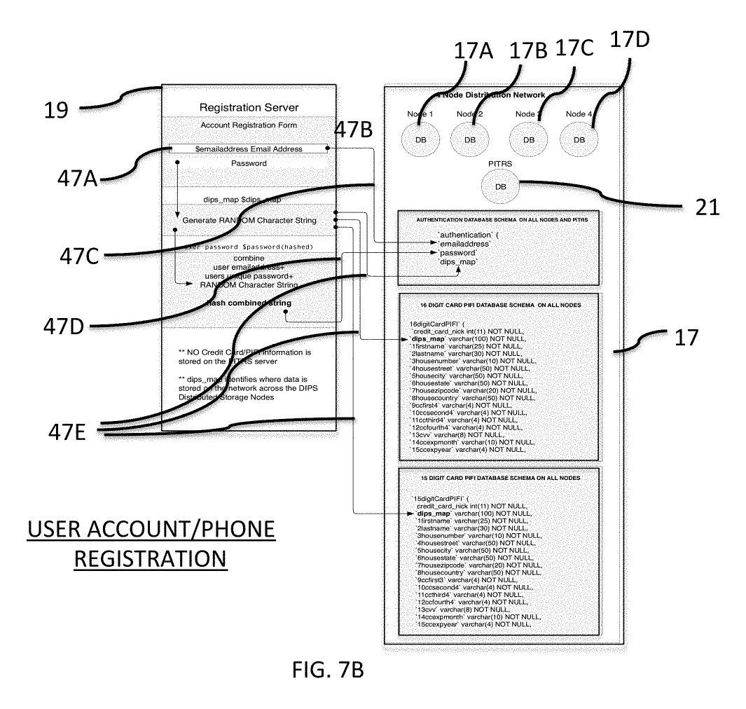

FIGS. 7A-1, 7A-2 and 7B describe the method of registering a user on the DIPS Service Network. As shown in FIGS. 7A-1 and 7A-2, the method involves the steps of: (a) downloading and installing DIPS Smartphone Application 18 on user's mobile smartphone 16; (b) using DIPS Smartphone Application 18, or visiting the DIPS network registration web page, user requests to register mobile smartphone 16 and installed DIPS Smartphone Application 18 on the DIPS Service Network; (c) as part of the DIPS network registration process, the DIPS Registration Server 19 requests the user to enter an email address and a password for user registration by transmitting an Account Registration Form 47A to the user DIPS smartphone app 18, as illustrated in FIG. 7B; (d) the user enters the email address and password into the Account Registration Form 47A on the user's smartphone 16, and then sends the Account Registration Form 47A to the DIPS Registration Server 19; (e) the DIPS Registration Server 19 stores the email address in the DIPS Database under the authentication column, as indicated at 47B in FIG. 7B; (f) the DIPS Registration Server 19 generates a random character string and stores it in the DIPS Database under the authentication example column labeled example dips_map, as illustrated at 47B in FIG. 7D; (g) the DIPS Registration Server 19 combines the user's email address and password into a single string (e.g. user.email@emailaddress.compassword), as shown in FIG. 7B; (h) the DIPS Registration Server 19 creates a hash of the combined string and stores that in the DIPS Database under the authentication table in the password column, as indicated at 47D in FIG. 7B; (i) the DIPS Registration Server 19 stores the random character string in the DIPS Distributed Database System 17 (17A, 17B, 17C, 17D) under every credit card table in the column example dips_map, using the DIPS distributed storage process, as indicated at 47E in FIG. 7B; and (j) after completing DIPS Network Registration, a registered user logs into the DIPS Service Network, providing an email address and password, and in response, the DIPS Authentication Server 20 combines the email address and password and checks the hash against the stored hash in the authentication table in the password column.

While the http protocol has been used to transport HTML-based Account Registration Forms such as 47A from the user's DIPS smartphone app 16 to the Registration Server 19, and between other locations on the DIPS Service Network, it is understood that other IP or socket based protocols may be used with excellent results, within the scope and spirit of the present invention.

### Specification of the Method of Registration of a Credit Card on the DIPS Services Network of the Present Invention

FIGS. 8A-1, 8A-2 and 8B-1 describe the method of registering a credit card (or debit card) of a registered user on the DIPS Services Network of the present invention.

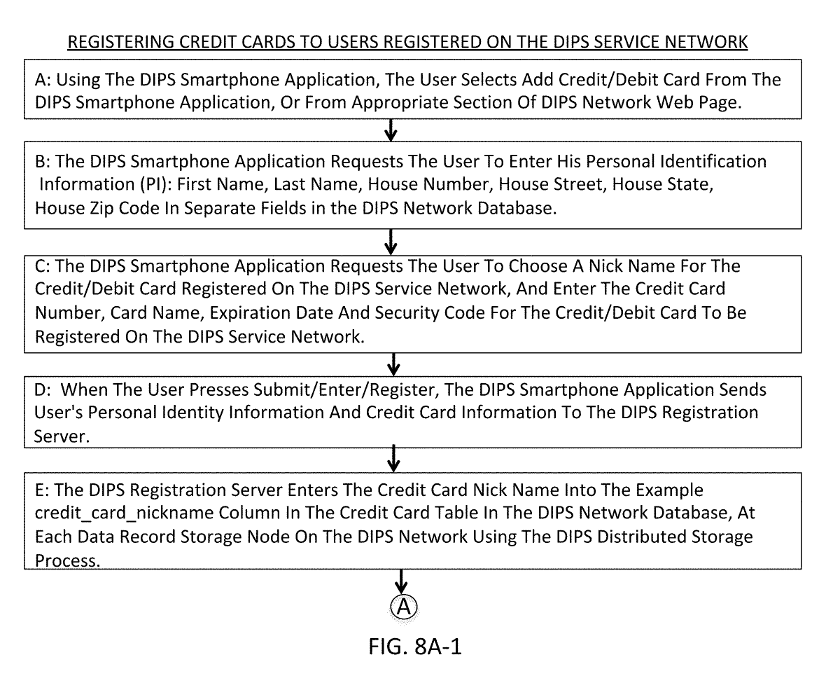

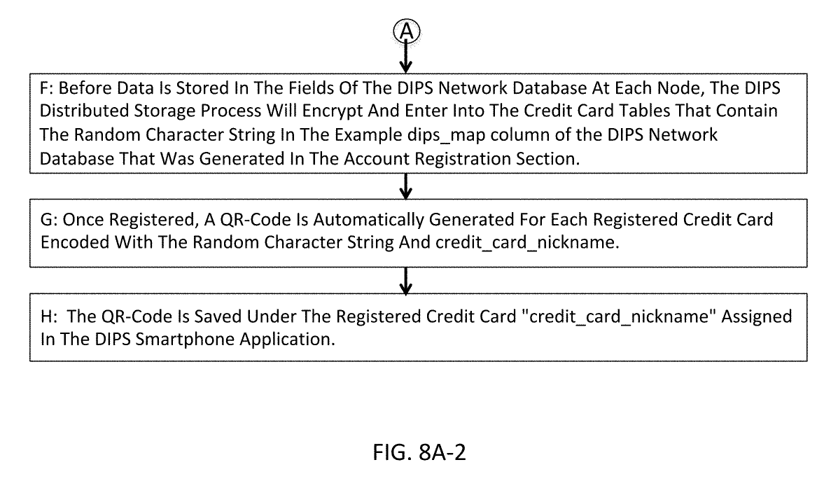

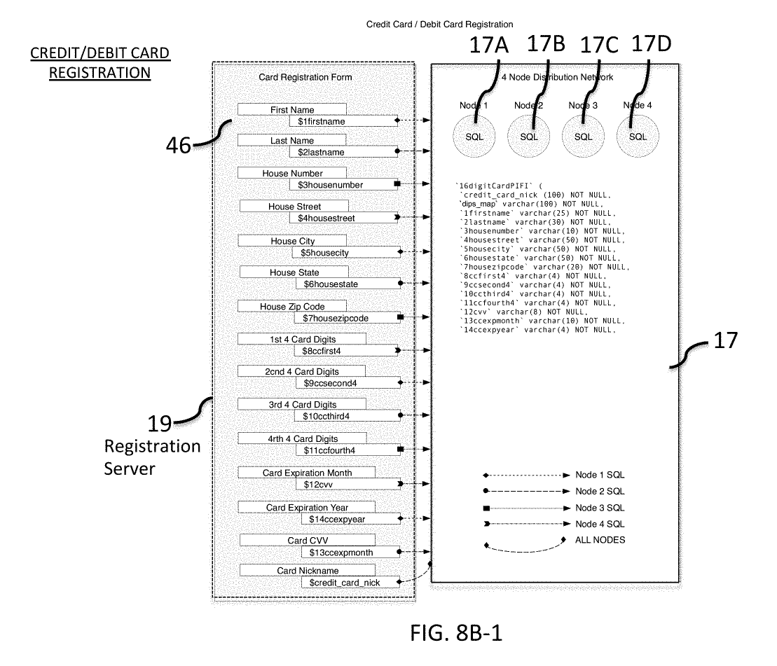

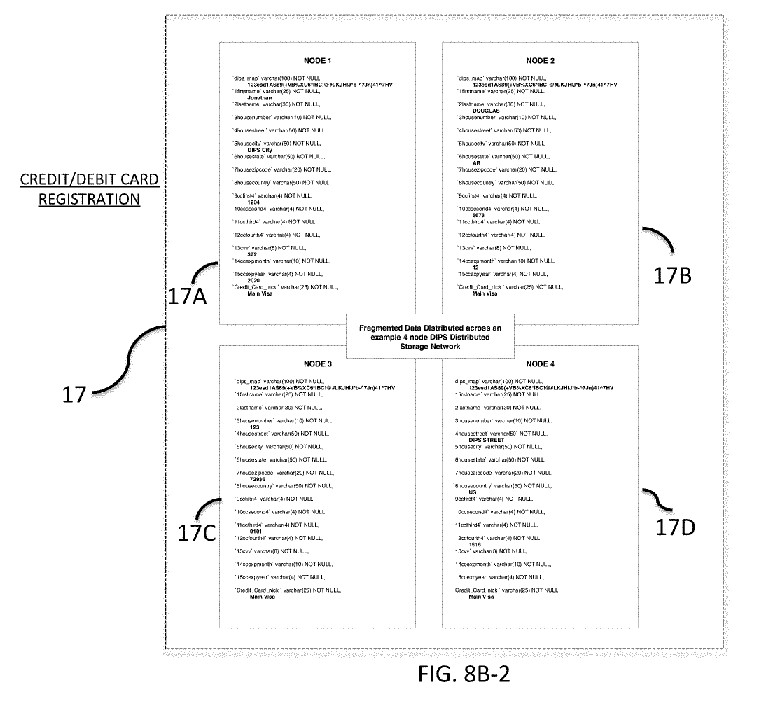

As shown in FIGS. 8A-1 and 8A-2, the method comprises: (a) using the DIPS Smartphone Application 18 installed on the user's mobile smartphone 16, the user selects add credit/debit card from the DIPS Smartphone Application 18, or from appropriate section of DIPS Network web page http://www.dipsnetwork.com; (b) the DIPS Smartphone Application 18 requests the user to enter his personal identification information (PII): first name, last name, house number, house street, house state, house zip code in separate fields, as shown in the HTML-based Credit Card Registration 46 illustrated in FIG. 8B-1; (c) the DIPS Smartphone Application 18 requests the user to choose a nick name for the credit/debit card registered on the DIPS Service Network, and enter the credit card number, card name, expiration date and security code for the credit/debit card into the Credit Card Registration Form 46, as shown in FIG. 8B-1, so that the corresponding credit card can be registered on the DIPS Service Network; (d) when the user presses submit/enter/register button provided with the Credit Card Registration Form 46, the DIPS Smartphone Application 18 sends user's personal identity information (PII) and credit card information to the DIPS Registration Server 19; (e) the DIPS Registration Server 19 automatically and transparently enters the credit card nick name into the example credit_card_nickname column in the credit card table in the SQL database maintained at each Data Record Storage Node in the DIPS Distributed Data Record Network (i.e. 17A, 17B, 17C, 17D) using the DIPS distributed storage process supported on the DIPS Service Network; (f) before data is stored in the fields of the SQL database of each Data Record Storage Node (17A, 17B, 17C, 17D), the DIPS distributed storage process automatically encrypts and enters into the credit card tables, a data that contains the random character string in the example dips_map column that was generated during User Account Registration; (g) once registered, a QR-code structure 25 is automatically generated for each registered credit card encoded with the random character string and credit_card_nickname; and (h) finally, the QR-code structure 25 is saved under the registered credit card “credit_card_nickname” assigned in the DIPS Smartphone Application 18. The registered credit is now ready for payment authorization on the DIPS Service Network.

While described in connection with an exemplary credit card account, it is understood that the above described card registration process can be used to register the user's bank debit card accounts as well using the DIPS Service Network of the present invention. A card schemas shown in FIG. 5B-1 can be used to register credit card accounts as well as debit card account, and generate PIFI data records that are automatically fragmented and stored across the DIPS Network Database in accordance with the principles of the present invention. As with PIFI data records constructed for a user's credit card account, PIFI data records will be constructed for a user's debit card accounts to be registered with the DIPS Service Network of the present invention so that such financial accounts are available for making payment for the purchase of goods and/or services using the DIPS Service Network. While the http protocol has been used to transport HTML-based Credit Card Registration Forms such as 46 from the user's DIPS smartphone app 16 to the Registration Server 19, and between other locations on the DIPS Service Network, it is understood that other IP or socket based protocols may be used with excellent results, within the scope and spirit of the present invention.

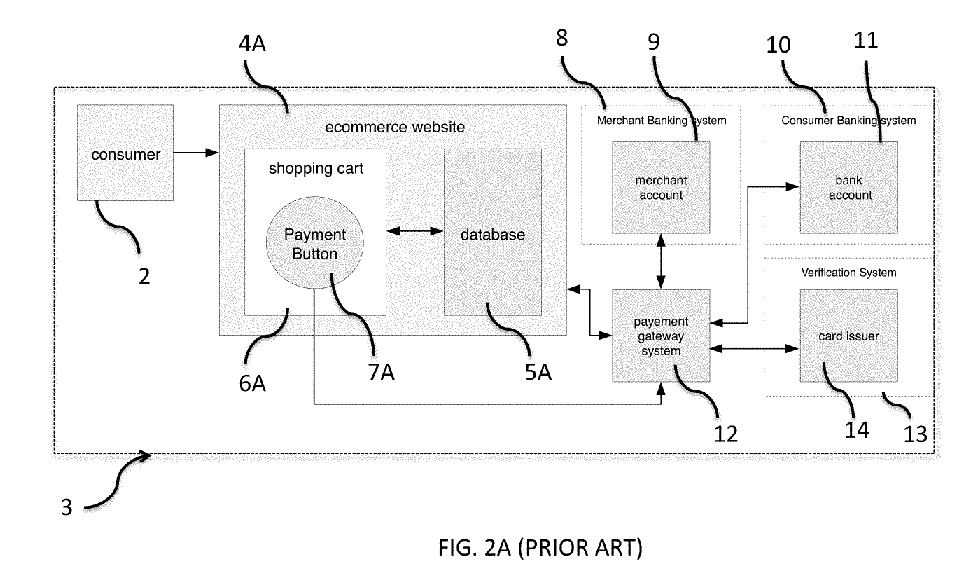

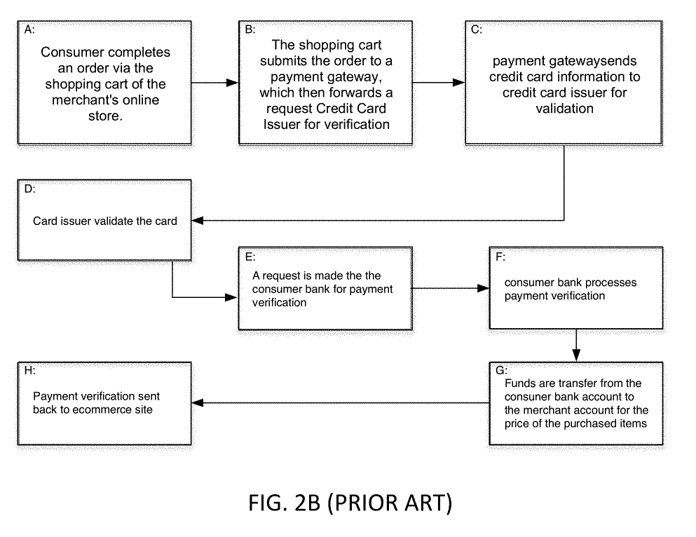

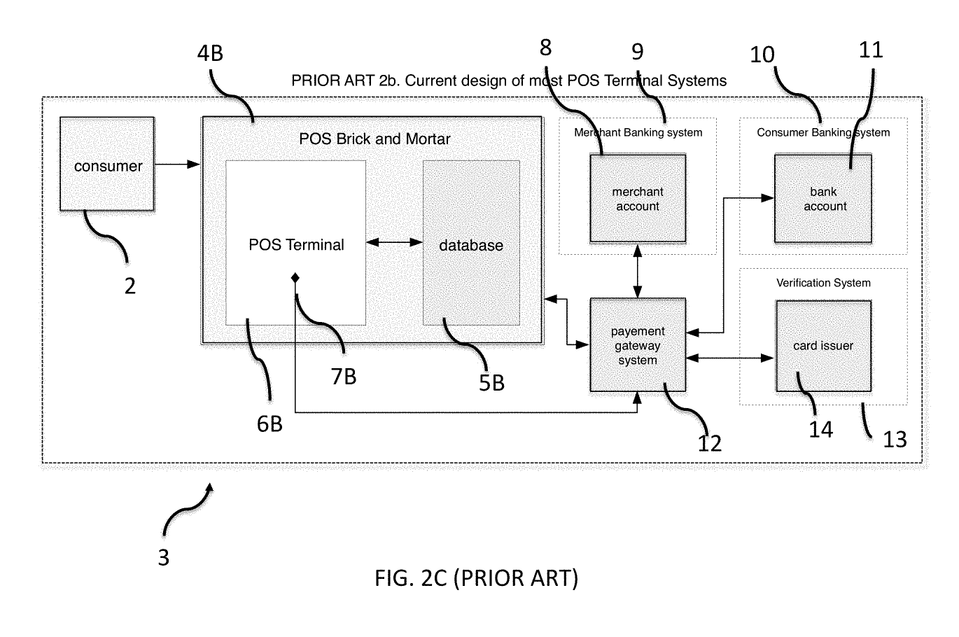

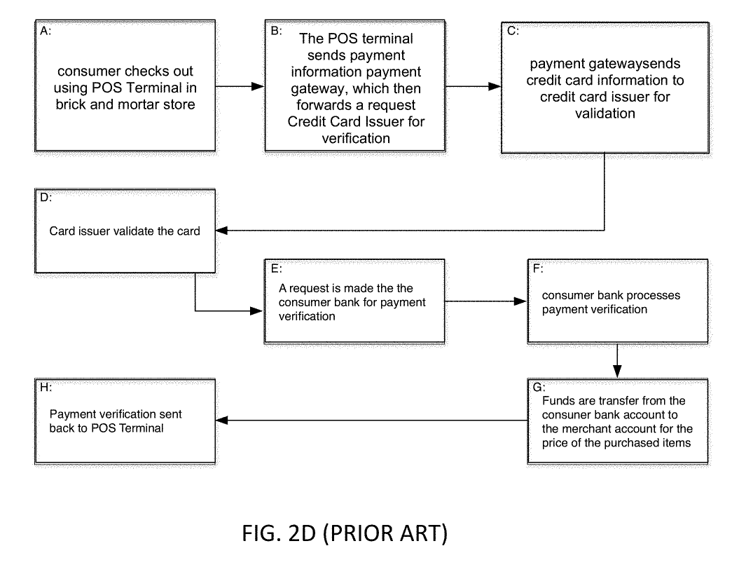

FIG. 8B-2 shows an exemplary PIFI data fragments are stored in the database tables of each node 17A (17B, 17C, 17D) in the four node DIPS Network Storage Network 17 of the illustrative embodiment. As shown, this four-node DIPS Distributed Storage Network 17 supports and implements the DIPS Network Database (i.e. RDBMS) used by the DIPS Service Network during all of its services. For example, in the exemplary case example, the PIFI data fragments (i.e. 1B-1, 1B-2, 1B-2, 1B3) represent a 16 digit credit card account and exemplary user (PIFI record) 1B, although it is understood that the DIPS Network Database will support credit and debit cards having a code length from 12 to 19 digits, and therefore, the database schema can be extended in a straightforward manner to support different length credit and debit card account numbers on the DIPS Service Network. As shown, in the illustrative embodiment, each node (17A, 17B, 17C and 17D) in the DIPS Distributed Storage Network 17 stores (i) only 4 digits of the user's registered credit card account, as well as (ii) partial fragments of the user's name and address information relating to the user's PIFI record, in accordance with the distributed information protection (DIP) principles of the present invention.

Specifically, consider the exemplary PIFI record based on a user's credit card account information, specifically: Jonathan Douglas; 123 DIPS Street; DIPS City, Ark. 72936 US; Credit Card Nickname Main Visa; Credit Card Number 1234-5678-9101-1516; Credit Card Expiration Date 12/2020; Credit Card CVV 372. Fragmentation and storage occurs as follows. distributed storage node 1 on the DIPS Storage Network stores the PIFI data fragment “first name (“Jonathan”)”. Distributed storage node 2 stores the PIFI data fragment “last name(“Douglas”)”. DIPS distributed storage node 3 stores PIFI data fragment “house/apt number(“123”)”. DIPS distributed storage node 4 stores PIFI data fragment “house street(“DIPS Street”)”. DIPS distributed storage node 1 stores PIFI data fragment “house city(“DIPS City”)”. DIPS distributed storage node 2 stores PIFI data fragment “house state(“AR”)”. DIPS distributed storage node 3 stores PIFI data fragment “house zip code(“72936”)”. DIPS distributed storage node 4 stores PIFI data fragment “house country(“US”)”. DIPS distributed storage node 1 stores PIFI data fragment “first four digits of credit card number(“1234”)”. DIPS distributed storage node 2 stores PIFI data fragment “second four digits of card number(“5678”)”. DIPS distributed storage node 3 stores the PIFI data fragment “third four digits of card number(“9101”)”. The DIPS distributed storage node 4 stores PIFI data fragment “fourth four digits of card number(“1516”)”. DIPS distributed storage node 2PIFI data fragment “card expiration month(“12”)”. DIPS distributed storage node 1 stores PIFI data fragment “card expiration year(“2020”)”. DIPS distributed storage node 1 stores PIFI data fragment “card cvv(“372”)”.

It is understood, however, that in alternative embodiments of the present invention, the digital code length stored at each node in the DIPS Storage Network 17 may be different than a 4 digit length, by design. Ideally, the fewer digits stored at each storage node, and the more nodes in the DIPS Storage Network 17, then the greater the inherent security designed into the system and network architecture.

Specification of the Payment Authorization Stage Supported at an E-Commerce Website Viewed by a Registered User on a Desktop, Laptop or Mobile Computer System, Having Access to his/her Registered Smartphone on which the DIPS Smartphone App is Installed

FIGS. 9A-1, 9A-2, 9A-3 and 9C describe the method of payment authorization supported at an e-commerce website 4A viewed by a registered user on a desktop, laptop or mobile computer system 40, having access to his/her registered smartphone 16 on which the DIPS Smartphone App 18 is installed. In the illustrative embodiment, the payment method is carried out using the DIPS Smartphone App 18, preferably with at least one data fragment 1B-1 stored in a first Data Record Storage Node 17A that is realized (i.e. implemented) on the memory of user's registered mobile smartphone system 16, running the DIPS Smartphone App 18, while all other data fragments are stored on distributed data record storage nodes (i.e. 17B, 17C, 17D) deployed on the DIPS Service Network. The format of each such data fragment stored on a respective storage node of the DIPS Service Network will be in a database format selected by the database developer. For the case of an Apple IOS-based iPhone 16, the database format for each data fragment will be for the SQLite database used in the development of the DIPS Smartphone App 18 for the Apple iPhone. Likewise, for the case an Android OS-based smartphone 16, the database format for each data fragment can be any database that the Android OS or Android SDK supports.

Notably, the data fragment storage configuration illustrated in FIGS. 3A 3B and 5A, in which at least one data fragment is stored on the user's registered DIPS Smartphone Application 18, has an inherent advantage over other network storage configurations as shown in and represented by the network configuration shown in FIG. 3C, where there are no data fragments, associated with the user's PIFI data record 1B, that are stored on the user's mobile smartphone or with the user's registered DIPS Smartphone Application 18.

In general, the DIPS-based payment authorization method of the present invention involves the following: (i) the selection and checkout of goods and/or services at the e-commerce shopping cart 4A; (ii) selection of payment button at the e-commerce site; (iii) selection of credit or debit card to make the payment from the payment card selection menu supported on the DIPS smartphone application 18 and (ii) followed by payment authorization over the DIP Services Network of the present invention, in order to make a financial payment transaction through the merchant's payment gateway system 12, to complete the safe and secure purchase of goods and/services using the DIPS Services Network of the present invention.

As shown in FIGS. 9A-1, 9A-2 and 9A-3, the method of making payment transaction on an e-commerce website, while browsing the website on a PC or laptop or tablet computer 40, while the user has a mobile smartphone 16 running the DIPS smartphone application.

As indicated at Block A in FIG. 9A-1, the method comprises the consumer/user using a web browser application running on a personal or laptop computer or table computer 40, to view merchant's e-commerce website which is coded with an HTML-encoded payment button 7A′ linked to the DIPS Service Network 15, 15′, 15″.

As indicated at Block B in FIG. 9A-1, when a user makes payment for a purchase on the merchant's e-commerce site, the user clicks the payment button 7A′, and in response to clicking the payment button, the merchant's e-commerce site serves a web page showing the total purchase price required for payment (i.e. Wal-Mart, greenwood, ar, $27.51).

As indicated at Block C in FIG. 9A-1, the User logs into the DIPS authentication server by entering his/her email address and password during the login process.

As indicated at Block D in FIG. 9A-1, the user logs into the Authentication Server by entering his/her email address and password. During the login process, the user logs into the DIPS PITRS 21, and the DIPS PITRS 21 combines the username (e.e. email address) and password into a single string and compares the hash of the string with the stored hash. If the both of the hashes match, then user authentication is complete, and a “proceed with payment” button is presented in the updated web page viewed in the browser of the user's computer.

As indicated at Block E in FIG. 9A-1, user clicks the push notification's “authorize payment” button, causing the DIPRS PITRS 21 to send a push notification to the user's smartphone requesting final authorization.

As indicated at Block F in FIG. 9A-2, the user clicks the push notification's “authorize payment” button, which opens the user's DIPS Smartphone Application 18.

As indicated at Block G in FIG. 9A-2, the DIPS Smartphone Application requests authentication using username (e.g. email address), password, and/or biometrics, which are transmitted to the DIPS PITRS 21.

As indicated at Block H in FIG. 9A-2, the DIPS PITRS 21 authenticates the user using a hash comparison stored in the Authentication Table in the DIPS Distributed Database System on the DIPS Service Network.

As indicated at Block I in FIG. 9A-2, the DIPS Smartphone Application 18 presents a menu of registered credit and/or debit cards (i.e. in terms of the registered card nicknames) for use in making the purchase payment, and the user then selects one of these registered credit cards from the menu for use in making payment.

As indicated at Block J in FIG. 9A-2, the card nickname for the selected credit card is provided to the DIPS PITRS 21.

As indicated at Block K in FIG. 9A-2, the DIPS PITRS 21 gathers all PIFI data record fragments in the DIPS network database, from all distributed data record storage nodes using an SQL query containing the random character string and the card nick name of the user selected credit/debit card.

As indicated at Block K in FIG. 9A-2, the DIPS PITRS 21 decrypt the PIFI Data Record Fragments retrieved from the DIPS network database.

As indicated at Block L in FIG. 9A-2, the PITRS decrypts the PIFI Data Record Fragments (1B-1, 1B-2, 1B-3, 1B-4) from all of the retrieved fields across all the DIPS Distributed Data Record Storage Nodes 17A, 17B, 17C, 17D.

As indicated at Block M in FIG. 9A-3, the DIPS PITRS 21 takes the PIFI data record fragments (1B-1, 1B-2, 1B-3, 1B-4) from all of the retrieved fields across all the DIPS Distributed Data Record Storage Nodes 17A, 17B, 17C, 17D, and reassembles the data record fragments to create a properly formatted string or file, representative of the complete reassembled PIFI data record, that is sent to the merchant's payment gateway or payment system 12, for use in authorizing payment with the consumer's selected credit card.

As indicated at Block N in FIG. 9A-3, once credit card payment has been made to the merchant's bank account 9, payment confirmation is sent back to the DIPS Smartphone Application 18 via a push notification, as well as emailed to the registered email address associated with the user's DIPS User Account.

As indicated at Block 0 in FIG. 9A-3, the PITRS 21 updates the payment transaction log maintained in the DIPS log process and storage, while the merchant updated transaction logs for the merchant's e-commerce website 4A.

Specification of Method of Making a Purchase Payment on a Merchant's E-Commerce Website being Viewed by the User Running a Smartphone with a Web Browser and DIPS Smartphone Application

FIGS. 9B-1, 9B-2, and 9B-3, and 9C describe the method of payment authorization supported by the e-commerce website represented in FIG. 5A1. As shown, in this case, the consumer user is browsing a merchant's e-commerce site 4A using a web browser running on the user's registered smartphone 16, on which the DIPS Smartphone App 18 has been installed and registered with the DIPS Service Network. In the illustrative embodiment, a purchase payment method is carried out using the DIPS Smartphone App 18, preferably with at least one data fragment stored in a first distributed Data Record Storage Node 17A in the user's registered smartphone 16 running the DIPS Smartphone App 18, while other data fragments are stored on distributed Data Record Storage Nodes 17B, 17C, 17D deployed on the DIPS Services Network.

In general, the method involves the following: (i) the selection and checkout of goods and/or services at the e-commerce shopping cart; (ii) selection of payment button 7A′ at the commerce site 4A; (iii) selection of credit or debit card to make the payment; and (ii) followed by payment authorization over the DIP Services Network, in order to make a financial payment transaction through the payment gateway system 12 of the e-commerce store, to complete the safe and secure purchase of goods and/services using the DIPS Services Network.

More specifically, as shown in FIGS. 9B-1, 9B-2, 9B-3 and 9C, the payment method comprises a number of steps described below.

As indicated at Block A in FIG. 9B-1, using a web browser running on the user's mobile smartphone 16 on which the DIPS Smartphone Application 18 is installed and running, the user views merchant's e-commerce website which is coded with an html-encoded payment button 7A′ linked to the DIPS Service Network.

As indicated at Block B in FIG. 9B-1, when a user is ready to check out and make a payment for a purchase on the merchant's e-commerce site, the user clicks the payment button 7A′.

As indicated at Block C in FIG. 9B-1, in response, a web page is served showing the total purchase price required for payment (i.e. Wal-Mart, greenwood, ar, $27.51), and the DIPS smartphone application is automatically launched on the user's smartphone, and fields are presented for the user to log into the DIPS service network.

As indicated at Block D in FIG. 9B-1, the user logs into the DIPS Authentication Server 20 by entering his/her email address and password, and/or biometrics. During the login process, the DIPS PITRS 21 combines the username (e.g. email address) and password into a single string and compares the hash of the string with the stored hash. If the both of the hashes match, then user authentication is completed, and a “proceed with payment” button is presented in the updated web page on the user's smartphone or mobile computing device 16 (e.g. Apple iPad).

As indicated at Block E in FIG. 9B-1, the user clicks the “proceed with payment” button 7B′ illustrated in FIG. 9C, causing the PITRS 21 to send a push notification to the user's smartphone 16 requesting final authorization.

As indicated at Block F in FIG. 9B-2, the DIPRS Smartphone Application 18 presents a menu of registered credit and/or debit cards (i.e. in terms of the registered card nicknames) for use in making the purchase payment, and the user then selects one of these registered cards from the menu for use in making payment.

As indicated at Block G in FIG. 9B-2, the Card Nickname for the selected registered credit/debit card is provided to the PITRS 21.

As indicated at Block H in FIG. 9B-2, the PITRS 21 then gathers all fields from all DIPS distributed Data Record Storage Nodes 17A, 17B, 17C, 17D using an SQL query containing the random character string (i.e. dips_map character string) and the card nick name of the user selected credit/debit card.

As indicated at Block I in FIG. 9B-2, the PITRS 21 decrypts the PIFI Data Record Fragments retrieved from the nodes of the DIPS Database Network.

As indicated at Block J in FIG. 9B-3, the PITRS 21 takes PIFI data record fragments (1B-1, 1B-2, 1B-3, 1B-4, etc.) from all of the retrieved database fields across all DIPS distributed Data Record Storage Nodes 17A, 17B, 17C, 17D, and reassembles the PIFI data record fragments to create a properly formatted string or file, representative of the complete PIFI data record, that is sent to the merchant's payment gateway or payment system 12, for use in authorizing payment with the consumer's selected credit/debit card.

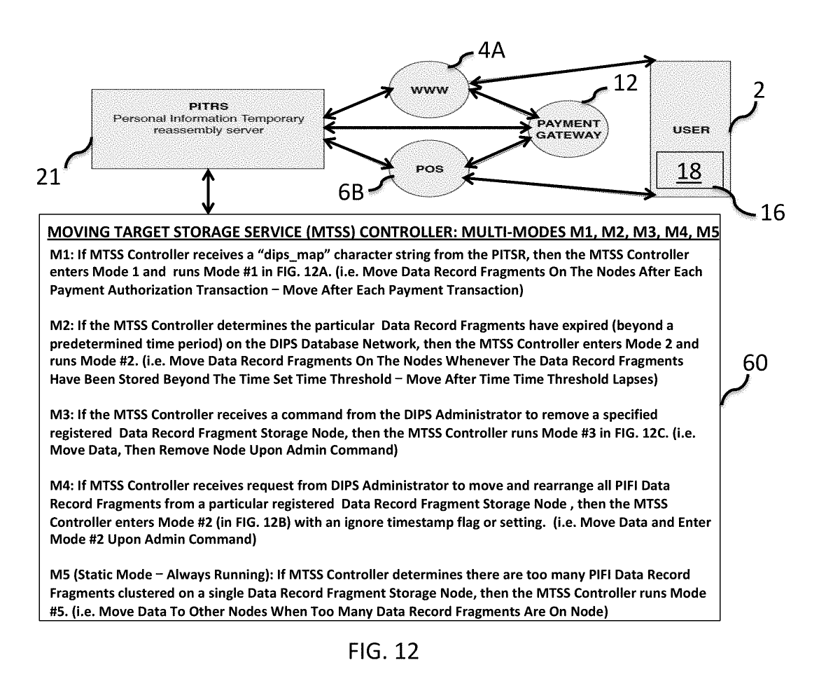

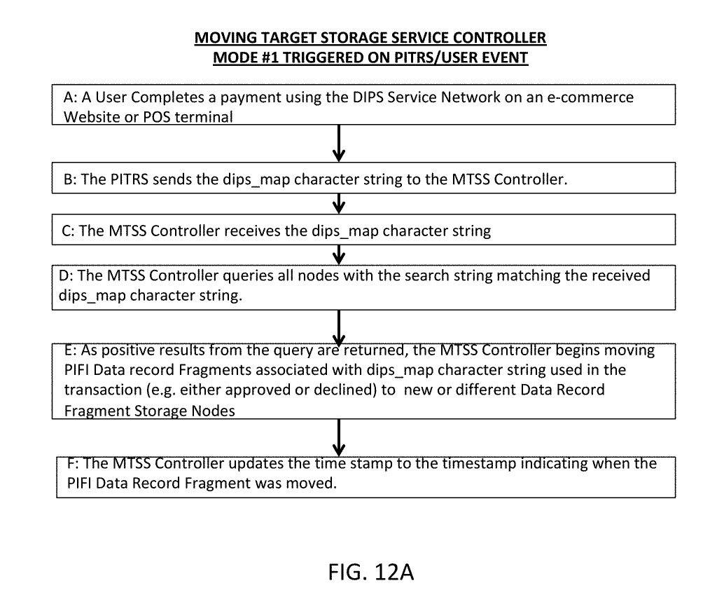

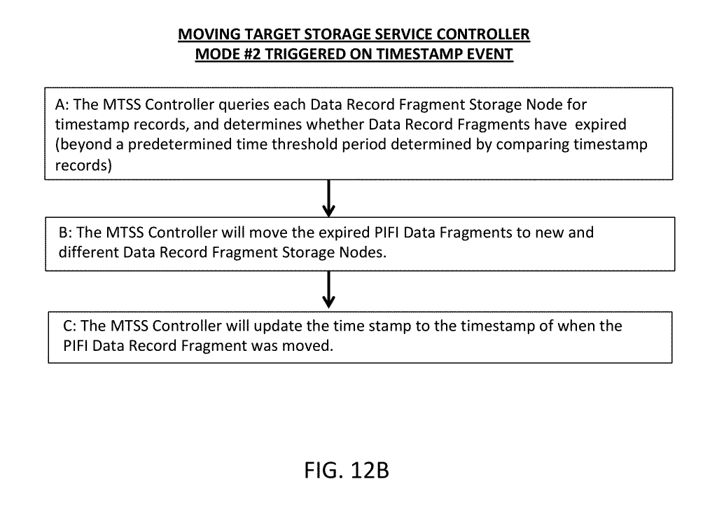

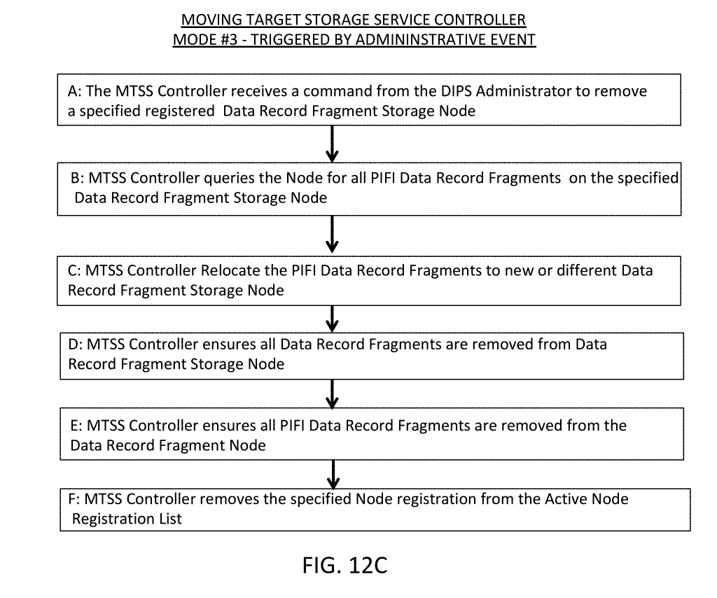

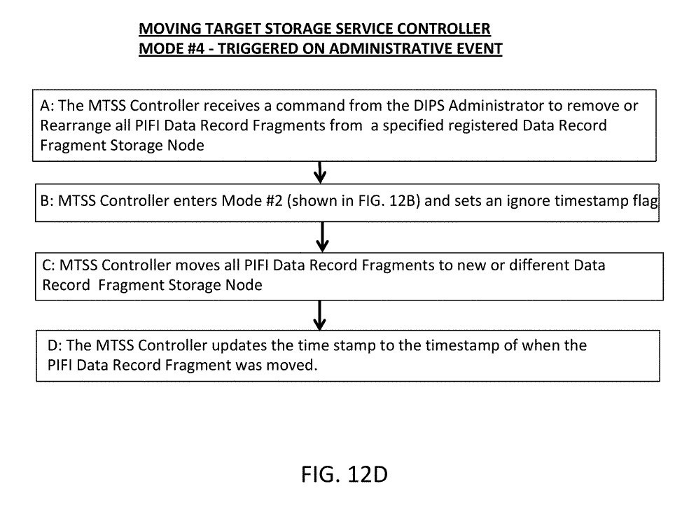

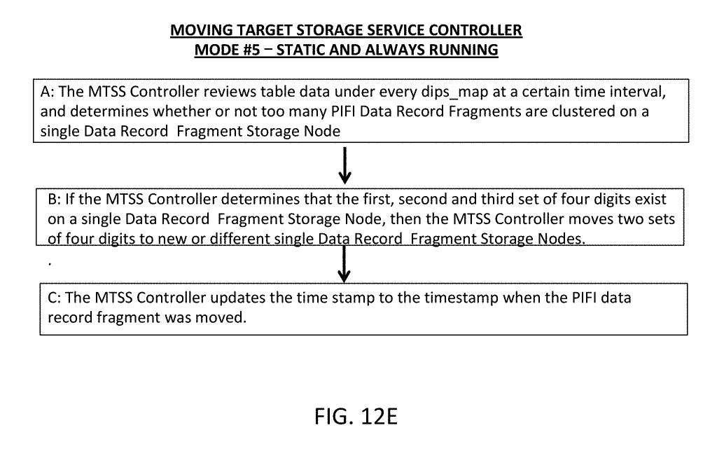

As indicated at Block K in FIG. 9B-3, once credit card payment has been made to the merchant's bank account 9, payment confirmation is sent back to the DIPRS smartphone application 18 via a push notification, as well as emailed to the registered email address associated with the user's DIPS account, as well as to the MTSS Controller 60 in FIG. 12.

As indicated at Block L in FIG. 9B-3, the PITRS 21 updates the payment transaction log maintained in the DIPS Network Database 17 in FIG. 5E, while the merchant updated transaction logs for the merchant's e-commerce website.

### Specification of Method of Making a Purchase Payment on a Merchant's POS-by A User Having a Smartphone Running the DIPS Smartphone Application

FIGS. 10A-1, 10A-2, 10A-3 and 10B describe the method of payment authorization supported by the POS terminal represented in FIG. 5A, before which the user is standing with his/her mobile smartphone 16, on which the DIPS Smartphone App 18 is installed. In the illustrative embodiment, the method is carried out using the DIPS Smartphone App 18, preferably with at least one data fragment stored in a first distributed database module in the user's registered smartphone 16 running the DIPS Smartphone App 18, while other data fragments are stored on distributed database servers (i.e. data record storage nodes) 17A, 17B, 17C, 17D deployed on the DIPS Services Network.

In general, the payment method is carried out at the POS terminal of the brick-and-mortar store, and involving (i) checkout of goods and/or services at the POS-terminal 6B in the brick-and-mortar store, (ii) using a code symbol scanner 6C interfaced to the POS terminal 6B to scan and read the customer's QR-code 25 displayed on the LCD screen of his/her mobile smartphone 16 running the DIPS Mobile application 18, (iii) selection of credit or debit card to make payment over the DIPS Service Network, and (iv) followed by payment authorization over the DIPS Services Network, in order to make a financial payment transaction at the POS terminal 6B, through the payment gateway system 12 of the brick-and-mortar store, to complete the safe and secure purchase of goods and/services using the DIPS Services Network.

More specifically, as described in FIGS. 10A-1, 10A-2 and 10A-3, the payment method involves the following steps described in detail below.

As indicated at Block A in FIG. 10A-1, the user/consumer making a purchase at merchant's store 4B, proceeds to a checkout counter having a POS-terminal 6B with code symbol scanner 6C.

As indicated at Block B in FIG. 10A-1, after item scanning operations, and during checkout, the POS-terminal 6B presents the consumer on a POS-based display screen, a total payment due for the purchases being made in the merchant's store.

As indicated at Block C in FIG. 10A-1, a hard-type or soft-type touch-screen “DIPS payment” button 7B′ is presented to the user on a touchscreen or via a physical button provided at the POS-terminal 6B as payment option.

As indicated at Block D in FIG. 10A-1, user presses the “DIPS payment” button 7B′ on the touch-screen or the physical button, and in response, the POS-terminal 6B requests a scan of the user's credit/debit card QR-code 25 displayed on the LCD screen of the user's smartphone 16 running the DIPS Smartphone Application 18.

As indicated at Block E in FIG. 10A-1, the user opens the DIPS Smartphone Application 18 running on the user's smartphone or mobile computing device 16, and authenticates with the DIPS Authentication Server 20, and then chooses the credit/debit card nickname for the registered credit/debit card account to be used to make the purchase payment, causing the credit/debit-card's corresponding QR-code 25 to be displayed on the LCD screen of the user's smartphone 16, to initiate the payment authorization process supported on the DIPS Service Network.

As indicated at Block F in FIG. 10A-2, the user then uses the optical code scanner 6C at the POS station 6B to scan and read the displayed QR-code 25 linked to the credit/debit card to be used to make payment for the purchase.

As indicated at Block G in FIG. 10A-2, the QR-code 25 is decoded by the POS-terminal 6B and the POS terminal 6B sends the random character string (i.e. dips_map character string), card nickname, store information, and purchase total to PITRS 21, as indicated at 49A in FIG. 10B, whereupon the PITRS 21 then performs an SQL query using the random character string (i.e. dips_map character string) and card nickname.

As indicated at Block H in FIG. 10A-2, the PITRS 21 gathers all PIFI data record fragments in the DIPS Network Database 17 from all distributed data record storage nodes, using an SQL Query containing the random character string (i.e. dips_map character string) and the card nick name of the user selected credit/debit card.

As indicated at Block I in FIG. 10A-2, the PITRS 21 decrypts the PIFI data record fragments retrieved from the SQL query results.

As indicated at Block J in FIG. 10A-3, the PITRS takes the PIFI data record fragments from all distributed storage nodes (17A, 17B, 17C, 17D) in the DIPS Distributed Network Database 17, and recombines all the PIFI data record fragments to create a properly formatted string or file, representative of the complete PIFI data record, that is sent to the payment gateway or payment system 12 of the merchant's e-commerce website, for use in authorizing payment with the consumer's selected credit/debit card.

As indicated at Block K in FIG. 10A-3, once credit card payment has been made to the merchant's bank account 9, payment confirmation is sent back to the DIPS Smartphone Application 18 via a push notification, as well as emailed to the registered email address associated with the user's DIPS Account, and also to the MTSS COntroller in FIG. 12.

As indicated at Block L in FIG. 10A-3, the PITRS 21 updates the payment transaction log maintained in the DIPS log process, while the merchant updated transaction logs for the merchant's brick and mortar store 4B.

Specification of Distributed Identity Protection System (DIPS) Services Network of the Present Invention Using an AI-Based Process that Intelligently Rotates the Storage Locations of the PIFI Data Record Fragments to Evade Cyber Threats and the Like

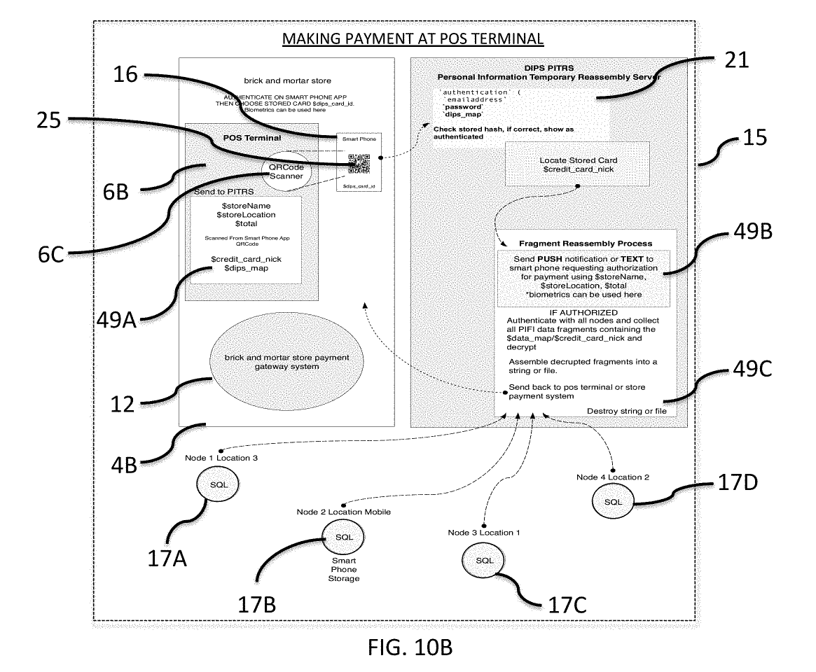

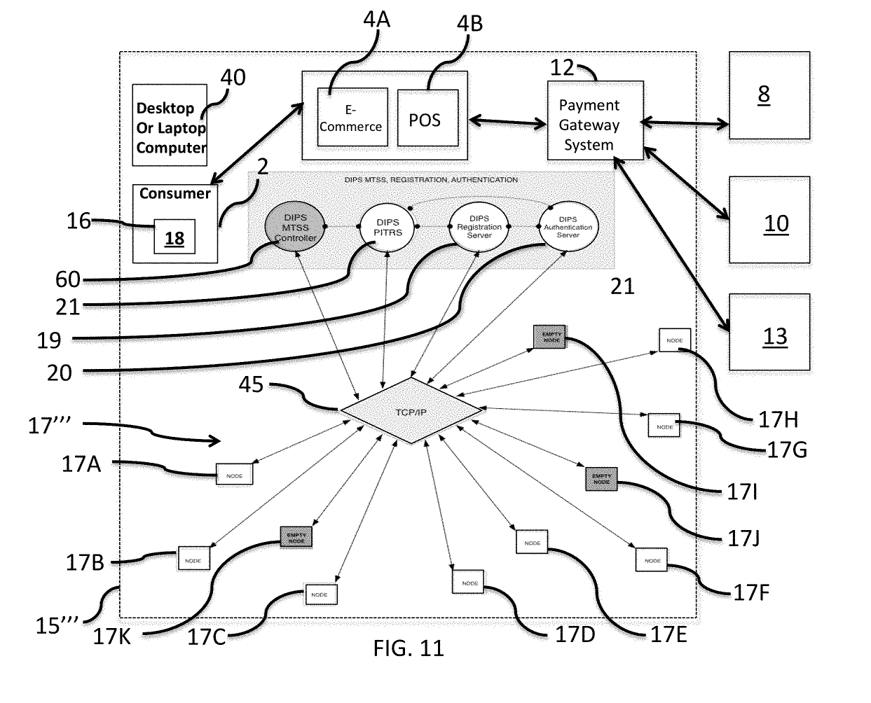

FIGS. 11 through 13B show an alternative DIPS Service Network of the present invention 15″ employing an AI-controlled data storage node network 17′. In general, DIPS Service Network 15′″ is the same as DIPS Service Networks 1, 15′ and 15″ except that Network 15″ supports more than five primary data record storage nodes 17A, 17B, 17C, 1D, and 167E for storing PIFI data fragments (1B-1, 1B-2, 1B-3, 1B-4, 1B-5 etc), and employs a special artificial-intelligence (AI)-based data relocation controller 60, called a Moving Target Storage Service (MTSS) controller 60, to move data record fragments in different locations on the DIPS Service Network so that cyber security threats are thwarted and/or evaded during network operation. As shown, the MTSS controller 60 is operably connected to the TCP/IP infrastructure of the Internet, and can communicate with PITRS 21, data record storage nodes 17A-17J supported on the network, and various network security appliances, as required. The MTSS Controller 60 moves and or rearranges PIFI Data Fragments around between nodes. It will sometimes move all data from the node to other nodes leaving the node empty of DIPS PIFI data fragments. The process of moving the data fragments from node to node creates a situation continuously changing as ones attempts deal with it, which is the definition of the phrase “moving target”. The movement of PIFI Data Fragments occurs whenever one of the following “events” described in the state transition diagram of FIG. 12, occurs.

In general, the MTSS controller 60 support an intelligent multi-modal control process involving, generally: (i) automatically monitoring particular data streams on the network and when detecting certain events, entering a particular mode from a set of five possible modes (i.e. M1 described in FIG. 12A, M2 described in FIG. 12B, M3 described in FIG. 12C, M4 described in FIG. 12D, and M5 described in FIG. 12E); (ii) automatically moving and/or processing PIFI data record fragments on the network as prescribed by the MTSS controller 60 depending on its current mode of operation; and (iii) automatically moving PIFI data record fragments to different node locations, as prescribed by the MTSS controller 60, while sometimes leaving data fragments in place on its current node, to evade cyber threats and other kinds of security risks.

As shown in FIG. 11, the DIPS Services Network 15′″ employs an eleven (11) storage node network and supports a DIPS payment authorization process according to the present invention comprising the steps: (i) automatically fragmenting user personally-identifiably financial information (PIFI) records into eight (8) data fragments; (ii) storing the data fragments in eight geographically/network-distributed data servers (i.e. storage nodes) on the DIPS Service Network using an AI-based process that moves or rotates the storage locations of the PIFI data record fragments according to algorithms controlled by the modes of operation (M1-M5) entered into by the MTSS controller 60 at any instant of operation based on monitored events on the DIPS Service Network; (iii) when payment authorization is required, the PITRS 21 automatically and temporarily recombining these data fragments into a complete PIFI data string, using the complete PIFI data string to authorize credit and debit card issuers, across the payment gateway system 12, and automatically destroying the recombined PIFI data record string to protect and secure the consumer's PIFI data record; and (iv) using the DIPS Smartphone App 18 on mobile phone 16 to request and authorize financial payment transactions between a consumer's bank account 11 and the bank account of the merchant 9, from whom the consumer is purchasing goods and/or services.

FIG. 12 illustrates the five modes supported on the Multi-Mode Moving Target Storage Service (MTSS) supported on the DIPS Service Network 15′″ illustrated in FIG. 11. As shown, the MTSS Controller 60 is programmed to enter any one of the five possible modes of data record fragment transformation (i.e. M1, M2, M3, M4 and M5) supported on the DIPS Database Network 17″, in response to the occurrence of particular events on the DIPS Service Network being continuously monitored by the MTSS Controller 60. A concise summary of each of these MTSS Controller modes operation is appropropriate at this juncture.

In the first mode M1, if MTSS Controller 60 receives a “dips_map” character string from the PITSR, then the MTSS Controller enters Mode #1 and runs Mode #1 in FIG. 12A. (i.e. Move Data Record Fragments On The Nodes After Each Payment Authorization Transaction—Move After Each Payment Transaction).

In the second mode M2, if the MTSS Controller determines the particular Data Record Fragments have expired (beyond a predetermined time period) on the DIPS Database Network, then the MTSS Controller 60 enters Mode #2 and runs Mode #2. (i.e. Move Data Record Fragments On The Nodes Whenever The Data Record Fragments Have Been Stored Beyond The Time Set Time Threshold—Move After Time Time Threshold Lapses).

In the third mode Ms, if the MTSS Controller 60 receives a command from the DIPS Administrator to remove a specified registered Data Record Fragment Storage Node, then the MTSS Controller runs Mode #3 in FIG. 12C (i.e. Move Data, Then Remove Node Upon Admin Command).

In the fourth mode M4, if the MTSS Controller 60 receives request from DIPS Administrator to move and rearrange all PIFI Data Record Fragments from a particular registered Data Record Fragment Storage Node, then the MTSS Controller enters Mode #2 (in FIG. 12B) with an ignore timestamp flag or setting. (i.e. Move Data and Enter Mode #2 Upon Admin Command).

In the fifth mode M5, if the MTSS Controller 60 determines there are too many PIFI Data Record Fragments clustered on a single Data Record Fragment Storage Node, then the MTSS Controller runs Mode #5 (i.e. Move Data To Other Nodes When Too Many Data Record Fragments Are On Node).

FIG. 12A describes the primary steps carried out by the multi-mode MTSS Controller when entering the first Mode #1 of data record fragment movement triggered by a PITRS/User event.

As indicated at Block A in FIG. 12A, the user completes a payment using a DIPS Service Network 15′″ on an ecommerce website 4A or POS terminal 6B.

As indicated at Block B in FIG. 12A, the PITRS 21 sends the dips_map character string to the MTSS Controller 60.

As indicated at Block C in FIG. 12A, the MTSS Controller 60 receives the dips_map character string.

As indicated at Block D in FIG. 12A, the MTSS Controller 60 queries all nodes with the search string matching the received dips_map character string.

As indicated at Block E in FIG. 12A, As positive results from the query are returned, the MTSS Controller begins moving PIFI Data record Fragments associated with dips_map character string used in the transaction (e.g. either approved or declined) to new or different Data Record Fragment Storage Nodes.

As indicated at Block F in FIG. 12A The MTSS Controller updates the time stamp to the timestamp indicating when the PIFI Data Record Fragment was moved.

FIG. 12B describes the primary steps carried out by the multi-mode MTSS controller 60 when entering the second Mode #2 of data record fragment movement triggered by a timestamp event.

As indicated at Block A in FIG. 12B, the MTSS controller 60 queries each Data Record Fragment Storage Node for timestamp records and determines whether PIFI data record fragments have expired (beyond a predetermined time period determined by comparing timestamp records).

As indicated at Block B in FIG. 12B, the MTSS controller 60 Controller will move the expired PIFI Data Fragments to new and different Data Record Fragment Storage Nodes.

As indicated at Block C in FIG. 12B, the MTSS controller 60 will update the time stamp to the timestamp of when the PIFI data record fragment was moved.

FIG. 12C describes the primary steps carried out by the multi-mode MTSS Controller when entering the third Mode #3 of data record fragment movement triggered by an admin event.

As indicated at Block A in FIG. 12C, the MTSS Controller 60 receives a command from the DIPS Administrator to remove a specified registered Data Record Fragment Storage Node.

As indicated at Block B in FIG. 12C, the MTSS Controller 60 queries the Node for all PIFI Data Record Fragments on the specified Data Record Fragment Storage Node.

As indicated at Block C in FIG. 12C, the MTSS Controller 60 Relocate the PIFI Data Record Fragments to new or different Data Record Fragment Storage Node.

As indicated at Block D in FIG. 12C, MTSS Controller 60 ensures all Data Record Fragments are removed from Data Record Fragment Storage Node.

As indicated at Block E in FIG. 12C, MTSS Controller 60 ensures all PIFI Data Record Fragments are removed from the Data Record Fragment Node.

As indicated at Block F in FIG. 12C, MTSS Controller 60 removes the specified Node registration from the Active Node Registration List.

FIG. 12D describes the primary steps carried out by the multi-mode MTSS Controller when entering the fourth Mode #4 of data record fragment movement triggered by an admin event.

As indicated at Block A in FIG. 12B, the MTSS Controller 60 receives a command from the DIPS Administrator to remove or rearrange all PIFI Data Record Fragments from a specified registered Data Record Fragment Storage Node.

As indicated at Block B in FIG. 12B, the MTSS Controller 60 enters Mode #2 (shown in FIG. 12B) and sets an ignore timestamp flag.

As indicated at Block C in FIG. 12B, the MTSS controller 60 moves all PIFI Data Record Fragments to new or different Data Record Fragment Storage Node.

As indicated at Block D in FIG. 12D, the MTSS Controller 60 updates the time stamp to the timestamp of when the PIFI Data Record Fragment was moved.

FIG. 12E describes the primary steps carried out by the multi-mode MTSS Controller when entering the fifth Mode #5 of data record fragment movement—which is a static mode.

As indicated at Block A in FIG. 12B, the MTSS Controller 60 reviews table data under every dips_map at a certain time interval, and determines whether or not too many PIFI Data Record Fragments are clustered on a single Data Record Fragment Storage Node (i.e. that there is never too many fragments clustered on a single node.)

As indicated at Block B in FIG. 12B, in the event that the MTSS Controller 60 determines the first, second and third set of four digits exist on a single node then, then MTSS controller 60 moves two sets of four digits to new different nodes (i.e. in the case of a 16 digit credit card number).

As indicated at Block C in FIG. 12B, the MTSS Controller 60 will update the time stamp to the timestamp when the PIFI data record fragment was moved.

By virtue of this unique combination MTSS controller modes of operation, the DIPS Service Network can ensure that each set of distributed PIFI data record fragments, stored in the nodes of DIPS Distributed Data Record Storage Network 17, are free from the danger and peril posed by any cyber security attacks that may arise on the DIPS Service Network.

In alternative embodiments, one or more modes may be activated in the MTSS controller 60. The multi-mode MTSS controller 60 may also be used in combination with intelligence network security appliances that analyze, in real-time, digital data packets at the data record fragment storage nodes of the network, and adapt strategies for data fragment storage location, based on monitored network conditions.

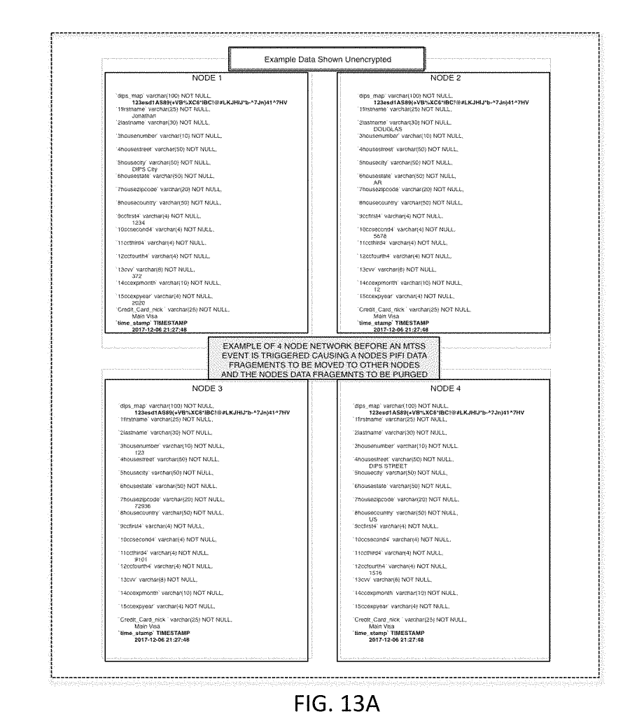

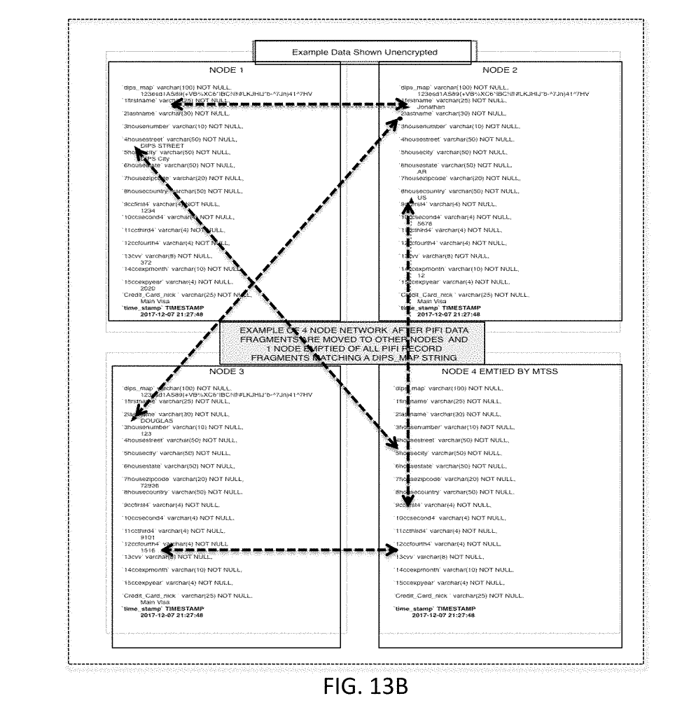

FIG. 13A shows database tables maintained at four data record fragment storage nodes on the DIPS Service Network being managed by the multi-mode MTSS Controller of the present invention. FIG. 13B shows database tables maintained at the same four data record fragment storage nodes on the DIPS Service Network illustrated in FIG. 13A, after the PIFI data record fragments have been moved to other nodes on the storage network, and one node has been emptied of all PIFI data record fragments matching a dips_map character string, used to identify where each unique set of PIFI data record fragments are stored on the DIPS Service Network.

Specification of Method of and System for Issuing New Credit and Debit Accounts Maintained within Banking Systems, for Making Payments for Goods and Services Purchased at E-Commerce and Brick-And-Mortar Stores Using Mobile Computer Applications, without the Issuance of Physical Credit or Debit Cards Bearing Personally-Identifiable Financial Information (PIFI)

The method of and system for the present invention enables issuing and maintaining new credit and debit accounts within banking systems, for making payments for goods and services purchased at e-commerce and brick-and-mortar stores using mobile computer applications, but without the issuance of physical credit or debit cards bearing PIFI.

During purchase payment transactions, the DIPS Smartphone Application 18 transparently access and recombine PIFI data fragments 1B-1, 1B-2, 1B-3, 1B-4, 1B-5 stored on data record storage nodes 17A, 17B, 17C, 17D distributed across the DIPS Service Network, for the purpose of requesting payment authorization by credit account or debit account authorization systems. Using this method, there is never a need to issue physical credit card or debit card bearing PIFI record 1B, or ever having to reveal such PIFI at any time during the payment transaction. However, a DIPS Service Network card may be issued, as a symbolic reminder of the existence of the DIPS User Account, and may bear the name of the User Account, while the user password is committed to memory of the user for use during login operations on the DIPS Service Network.

Modifications that Come to Mind

While the DIPS Service Network has been described as a service network for protecting PIFI used in authorizing and executing financial payment transactions, which are typically carried out behind electronic payment gateway systems employed by retail online and brick-and-mortar stores, it is understood that the any of these DIPS systems and service networks may be modified and used in other applications, such as personal health/medical record storage and access over digital networks, federal and state tax record. How any such DIPS based system may be used will depend on various factors including governmental regulations operating in the industries across which such deployment occurs.

While the http protocol has been used to transport HTML forms from the user's DIPS smartphone app 16 to the Registration Server 19 and the PITRS 21, and between other locations on the DIPS Service Network, it is understood that other IP or socket based protocols may be used with excellent results, within the scope and spirit of the present invention.

These and all other such modifications and variations are deemed to be within the scope and spirit of the present invention as defined by the accompanying Claims to Invention.

1. A method of registering a credit card or debit card account of a registered user on the distributed identity protection system (DIPS) service network comprising steps of:
(a) using a mobile application installed on a user's mobile smartphone, to add and register a credit or debit card account on said DIPS service network;
(b) said mobile application requesting the user to enter his personal identification information (PII): first name, last name, house number, house street, house state, house zip code in separate fields;
(c) said mobile application requesting the user to choose a nick name for the card being registered on said DIPS service network, and entering the card number, card name, expiration date and security code for the card, so that the corresponding card can be registered on said DIPS service network;
(d) when the user requests registration of the credit or debit card account, said mobile application sends the user's personal identity information (PII) and credit or debit card account information, collectively defined as a personal identifiable financial information (PIFI) data record, to a registration server maintained on said DIPS service network; and
(e) said registration server automatically and transparently fragmenting the PIFI data record into data record fragments, and storing these PIFI data record fragments in the data record storage nodes of distributed data record storage network maintained by said DIPS service network.

2. The method of claim 1, which further comprises:
(f) once registered, automatically generating a code symbol structure for said registered credit or debit card account; and
(h) storing said code symbol structure in said mobile application, under the card nickname, and available for selection for payment authorization on said DIPS service network.

3. The method of claim 1, wherein said PIFI data fragments are stored in the database tables of each distributed storage node in the DIPS network storage.

4. The method of claim 1, wherein the PIFI data fragments represent a credit or debit card account having a code length from 12 to 19 digits.

5. The method of claim 1, wherein said PIFI data record comprises: first name; last name; house/apt number; house street; house city; house state; house zip code; house country; card nickname; credit card number; card expiration date; and card cvv.

6. A method of PIFI data record fragmentation and distributed storage comprising:
(a) during a credit/debit card registration process, automatically analyzing, fragmenting, distributing and storing the PIFI records of consumers registered on a DIPS service network; and
(b) during a payment authorization process, automatically and temporarily recombining said PIFI data record files to form a complete PIFI data string, and transmitting said complete reassembled PIFI data string through a payment gateway system to the credit or debit card issuers for payment authorization, and immediately thereafter, automatically destroying the reassembled PIFI data string to preserve and secure the PIFI records on said DIPS service network.

7. The method of claim 6, wherein during the credit/debit card registration process, the user's PIFI record is automatically fragmented into multiple data fragments, and these multiple data fragments are then stored in multiple geographically/network distributed data storage nodes on the DIPS service network.

8. The method of claim 6, wherein during said payment authorization process,
(i) said consumer requesting payment using a credit/debit card registered on said DIPS service network;
(ii) in response to the request for payment authorization, automatically and temporarily accessing the multiple data fragments stored across distributed network of data storage servers, and recombining these retrieved PIFI data record file fragments into a complete PIFI data string;
(iii) completing PIFI data string to authorize credit and debit card issuers through the payment gateway system;
(iv) automatically destroying the recombined PIFI data string to protect and secure the PIFI record; and
(v) executing the financial payment transaction between the consumer's bank account and the merchant's bank account, from whom the consumer is purchasing goods and/or services.

9. A payment authorization service network employing a distributed identity protection system (DIPS) across the TCP/IP infrastructure of the Internet, said payment authorization service network comprising:
at least one e-commerce store operated by a first merchant having a website supporting an e-commerce shopping cart and payment button, and operably connected to the TCP/IP infrastructure of the Internet;
at least one brick-and-mortar store operated by a second merchant equipped with one or more POS terminals operably connected to the TCP/IP infrastructure of the Internet, wherein each said POS station has an optical code symbol scanner for reading code symbols;
a payment gateway system operably connected to the TCP/IP infrastructure of the Internet, as well as said e-commerce shopping cart and payment button and each said POS terminal at said brick-and-mortar store, and in communication with a verification system operated by each credit card issuer and each debit card issuer, for verifying whether or not a user has sufficient credit to make payment for a given purchase transaction on said payment authorization service network;
a distributed network of data record storage nodes, each said node being operably connected to the TCP/IP infrastructure of the Internet;
a mobile computing device having a mobile application, and being operably connected to the infrastructure of the Internet;
a registration server operably connected to the TCP/IP infrastructure of the Internet, for registering (i) each user and creating a user account for the user on said payment authorization service network, and (ii) during a credit card registration process, registering one or more credit card accounts and/or one or more debit card accounts of the user, and to form a personal identifiable financial information (PIFI) data record for each registered credit card account and for each registered debit card account, and (iii) automatically fragmenting each said PIFI data record formed by said registration server, into multiple data record fragments, and storing said multiple data record fragments in the nodes of said distributed network of data record storage nodes; and
a personal information temporary reassembly server (PITRS) for (i) automatically accessing the multiple data record fragments stored in the nodes of said distributed network of data record storage nodes, by said registration server during the registration of each credit card account and/or debit card account of the user, (ii) reassembling the multiple data record fragments to form a complete PIFI data record when requested by the user to make a payment authorization on said payment authorization network using the mobile app installed on said mobile computing device, (iii) using the complete reassembled PIFI data record to authorize at said verification system a credit and debit card account issuer to make a payment for a purchase transaction using said payment gateway system, and (iv) upon receiving payment authorization, using the credit card account or debit card account to pay for the purchase of good or services involved in said purchase transaction.

10. The payment authorization service network of claim 9, which further comprises an authentication server operably connected to the TCP/IP infrastructure of the Internet, for logging users into said payment authorization service network, when desiring to make a payment authorization using said distributed identity protection system (DIPS).

11. The payment authorization service network of claim 9, wherein one of the nodes in said distributed network of data record storage nodes used to stored in a local database of the mobile application installed on the mobile computing device of the user registering the credit card account or debit card account.

12. The payment authorization service network of claim 9, wherein said registration server automatically (i) generates a unique code symbol for each registered credit card account and a unique code symbol for each said debit card account registered on said payment authorization service network, and (ii) loads said unique code symbol in the mobile application installed on the mobile computing device of the owner of the registered credit or debit card account, for display on the display screen of said mobile computing device when the user at one said POS station needs to make a payment for a purchase transaction using the corresponding credit card account or debit card account registered on said payment authorization service network.

13. The payment authorization service network of claim 9, wherein said mobile computing device is a mobile smartphone device.

14. The payment authorization service network of claim 9, wherein each node in said distributed network of data record storage nodes maintains a database table for each credit card account identified by a credit card number having a specified number of digits.

15-29. (canceled)
